(19) United States
(12) Patent Application Publication
(10) Pub. No.: US 2024/0044801 A1
(43) Pub. Date: Feb. 8, 2024

(54) AUTOCHEMOMETRIC SCIENTIFIC INSTRUMENT SUPPORT SYSTEMS

(71) Applicant: THERMO SCIENTIFIC PORTABLE ANALYTICAL INSTRUMENTS INC., Tewksbury, MA (US)

(72) Inventors: Lin ZHANG, Andover, MA (US); Nikita KHAINOVSKI, Marlborough, MA (US); Stephen SHEFSKY, Brooklyn, NY (US); Nimesh KHADKA, Dracut, MA (US)

(21) Appl. No.: 18/354,794

(22) Filed: Jul. 19, 2023

Related U.S. Application Data
(60) Provisional application No. 63/502,469, filed on May 16, 2023.
(60) Provisional application No. 63/369,397, filed on Jul. 26, 2022.

(51) Int. Cl. G01N 21/65

(52) U.S. Cl. CPC G01N 21/65; G01N 2201/1296

(57) ABSTRACT

Disclosed herein are scientific instrument support systems, as well as related methods, computing devices, and computer-readable media. For example, in some embodiments, a scientific instrument support system may be an autochemometric system that automatically trains machine-learning models with spectroscopy data. The trained models can then be used to identify and/or authenticate the presence of particular substances in a sample under test.

### BACKGROUND

A number of different analytical techniques may be applied to the challenge of identifying the chemical substances in a material sample. For example, in Raman spectroscopy, a laser may be directed onto a sample, and scattered light provides a spectrum indicated of the sample components.

There remains a need for improved speed, accuracy, and performance in applying these analytical techniques.

### SUMMARY

Systems, methods, and products to address these and other needs are described herein with respect to illustrative, non-limiting, implementations. Various alternatives, modifications and equivalents are possible.

According to a first aspect, a scientific instrument support system is described. The scientific instrument support instrument includes a first logic, a second logic, and a third logic. The first logic manages and pre-process a spectroscopic data set. The second logic trains one or more models and provide a trained model. The third logic provides a measure of the quality of the trained model and provide a one or more of a found hyperparameter of the trained model.

According to a second aspect, a Raman spectrometer is described. The Raman spectrometer includes the first logic, the second logic and the third logic according to the first aspect.

According to a third aspect, a method to identify, authenticate or quantify one or more substances in a sample under test is described. The method includes irradiating the sample with an excitation beam from a spectroscopy device; collecting data responsive to the excitation beam using the spectroscopic device; and processing the data using a scientific instrument support apparatus according to the first aspect.

According to a fourth aspect a method for scientific instrument support is described. The method includes; managing and pre-processing data, training one or more models to provide trained models, providing a measure of the quality of the trained model, and providing a one or more hyperparameter of the trained model.

According to a fifth aspect, one or more non-transitory computer readable media having instructions thereon is described. The instructions, when executed by one or more processing devices of a scientific instrument support apparatus, cause the scientific instrument support apparatus to perform the method according to the fourth aspect.

The aspects described herein provide improved speed, accuracy and performance in applying analytical techniques for identification training models of components in a sample.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, not by way of limitation, in the figures of the accompanying drawings.

FIG. 1 is an example of a molecular fingerprint in Raman spectroscopy, in accordance with various embodiments.

FIG. 2 is an example confusion matrix representation of classification results, in accordance with various embodiments.

FIG. 3 is an example epoch-loss curve for a one-class support vector machine (SVM), in accordance with various embodiments.

FIGS. 4-24 are example confusion matrix representations of classification results, in accordance with various embodiments.

FIG. 25 is a plot representing some hyperparameters, according to some embodiments.

FIG. 26 is a model prediction to known values plot, according to some embodiments.

FIG. 27 is a variable importance plot, according to some embodiments.

FIG. 28 is a block diagram of an example cloud architecture for an autochemometric scientific instrument support system, according to some embodiments.

FIG. 29 is a block diagram of an example scientific instrument support module for performing support operations, in accordance with various embodiments.

FIG. 30A is a flow diagram of an example method of performing support operations, according to some embodiments. FIGS. 30B-30E are flow diagrams of sub-operations for performing the support operations depicted by FIG. 30A.

FIG. 31 is an example of a graphical user interface that may be used in the performance of some or all of the support methods disclosed herein, according to some embodiments.

FIG. 32 is a block diagram of an example computing device that may perform some or all of the scientific instrument support methods disclosed herein, according to some embodiments.

FIG. 33 is a block diagram of an example scientific instrument support system in which some or all of the scientific instrument support methods disclosed herein may be performed, according to some embodiments.

FIG. 34A illustrates the quality of a model with user determined best hyperparameters.

FIG. 34B illustrates the quality of a model with hyperparameters determined according to some embodiments.

### DETAILED DESCRIPTION

Disclosed herein are scientific instrument support systems, as well as related methods, computing devices, and computer-readable media. For example, in some embodiments, a scientific instrument support system may be an autochemometric system that automatically trains machine-learning models with spectroscopy data. The trained models can be used to identify, authenticate and/or quantify particular substances in a sample under test.

The scientific instrument support embodiments herein may achieve improved performance relative to conventional approaches. For example, as discussed below, conventional approaches to train ML models with spectroscopic data are extremely labor-intensive. For this reason, and others discussed herein, the embodiments disclosed herein thus provide improvements to scientific instrument technology (e.g., improvements in the computer technology supporting such scientific instruments, among other improvements).

Various ones of the embodiments disclosed herein may improve upon conventional approaches to achieve the technical advantages of increased speed and accuracy by utilizing an automatic machine learning (AutoML) approach. Such technical advantages are not achievable by routine and conventional approaches, and all users of systems including such embodiments may benefit from these advantages (e.g., by assisting the user in the performance of a technical task, such as substance identification/authentication). The technical features of the embodiments disclosed herein are thus decidedly unconventional in the field of spectroscopy, as are the combinations of the features of the embodiments disclosed herein. The computational and user interface features disclosed herein do not only involve the collection and comparison of information but apply new analytical and technical techniques to change the operation of spectrometers and spectroscopy systems. The present disclosure thus introduces functionality that neither a conventional computing device, nor a human, could perform.

Accordingly, the embodiments of the present disclosure may serve any of a number of technical purposes, such as controlling a specific technical system or process; determining properties of a material sample by processing data obtained from spectrometric analysis; and providing a faster processing of spectroscopy data. In particular, the present disclosure provides technical solutions to technical problems, including but not limited to constructing ML learning models that can be used for substance identification and/or authentication in spectroscopy settings.

In the following detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made, without departing from the scope of the present disclosure. Therefore, the following detailed description is not to be taken in a limiting sense.

Various operations may be described as multiple discrete actions or operations in turn, in a manner that is most helpful in understanding the subject matter disclosed herein. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

For the purposes of the present disclosure, the phrases “A and/or B” and “A or B” mean (A), (B), or (A and B). For the purposes of the present disclosure, the phrases “A, B, and/or C” and “A, B, or C” mean (A), (B), (C), (A and B), (A and C), (B and C), or (A, B, and C). Although some elements may be referred to in the singular (e.g., “a processing device”), any appropriate elements may be represented by multiple instances of that element, and vice versa. For example, a set of operations described as performed by a processing device may be implemented with different ones of the operations performed by different processing devices.

The description uses the phrases “an embodiment,” “various embodiments,” and “some embodiments,” each of which may refer to one or more of the same or different embodiments. Furthermore, the terms “comprising,” “including,” “having,” and the like, as used with respect to embodiments of the present disclosure, are synonymous. When used to describe a range of dimensions, the phrase “between X and Y” represents a range that includes X and Y. As used herein, an “apparatus” may refer to any individual device, collection of devices, part of a device, or collections of parts of devices. The drawings are not necessarily to scale.

Disclosed herein are systems and methods that employ automated machine learning for training a model, where the models may be used for authentication and identification of different substances using spectroscopy.

The authentication and identification of unknown substances is an important step in manufacturing processes, customs screening, and in many other fields. Spectroscopy, of which there are many different types, can be used for these purposes. For example, in vibrational spectroscopy, including Infrared spectroscopy and Raman spectroscopy, a light beam probes molecular vibrations and rotations and the absorption, emission, reflection or scattering of the light is measured. In UV-visible spectroscopy, absorption, or reflectance of a light beam by virtue of electronic transitions in the sample are measured. Other spectroscopies can include x-ray energies, such as x-ray fluorescence which can identify chemical element compositions in compounds by virtue of inner shell electron excitation and relaxations. X-ray diffraction can identify crystalline materials by diffraction and interference of lattice planes in the crystalline material. The spectra obtained by these different methods can provide a fingerprint or unique arrangement of peaks that identify and quantify sample compositions and components such as molecules, elements, and crystalline phases. This fingerprint can be also a function of the measurement parameters and measurement instrument.

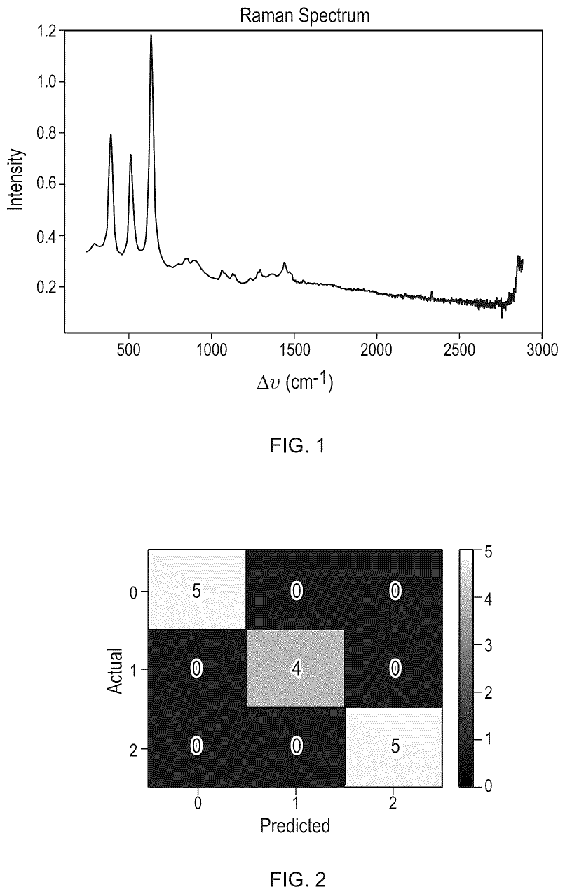

In some embodiments, the authentication and identification of unknown substances is made by Raman spectroscopy, where molecules are excited by monochromatic light, usually originating from a laser. Vibrational and rotational modes of the molecules can be activated by this interaction with photons. Because there is an energy difference between these states, the scattered photon will also have a different energy, resulting in a wavelength difference. By measuring the scattered light on a spectrometer, a fingerprint of the molecules can be determined. In samples that are mixtures of different substances, this spectrum will be a combination of these fingerprints. FIG. 1 shows an example of such a fingerprint. In FIG. 1, three very characteristic peaks are found in the low wavenumber region. The x-axis is given as the difference in wavenumber between incoming and outgoing light, where wavenumber is the inverse of light wavelength. The autochemometric systems and techniques disclosed herein may utilize any suitable type of spectroscopy.

To identify substances using spectroscopy, the measured spectra are compared with reference spectra using statistical models, which can be selected from a collection of suitable models. To create these models, several choices for model hyperparameters may be made, such as (but not limited to) pre-processing methods (including their own hyperparameters, like the window size in a Savitzy-Golay derivative), selected region parameters (where some of the spectrum is left out of consideration), and/or model-specific hyperparameters (such as the number of principal components in a principal components analysis (PCA) model).

Because of the high number of parameters, model creation by hand is a tedious task that has conventionally needed to be performed by a human expert for every model that is created. This is a time-consuming process, and the large dimensionality of the hyperparameter space makes it hard to find an optimal solution.

Disclosed herein are automated machine learning (AutoML) approaches that may address one or more of these issues. By automatically optimizing both model choice and/or finding hyperparameters, much more of the multi-dimensional parameter space can be covered, in a shorter amount of time and with less human effort. This can lead to better models in a shorter time. However, such an approach presents several challenges. Firstly, the size of the training data sets is generally very limited. This makes machine learning models prone to overfitting on the training data, leading to bad generalization of the models onto new data. Secondly, “outliers” may occur, in which a test sample does not belong to any of the training classes. Because these outliers can be of any random substance, and because they are not used during model creation, detecting and addressing outliers presents a significant challenge.

The systems and techniques disclosed herein may overcome these and/or other challenges to provide embodiments of successful automated machine learning methods for chemometrics. For example, various ones of the systems and methods disclosed herein may achieve accuracies of 80-90% for a number of different data sets, in a fully automatic way.

Various ones of the embodiments of the AutoML systems disclosed herein are presented along with results of testing these systems on various sample data sets to help further illustrate the potential applications and performance variations of the AutoML systems. In some embodiments, a qualitative model is desired, while in other embodiments a quantitative model is desired. These can be used to interrogate a species or analyte in a sample. In some embodiments, a qualitative model can be to model the kind species in the sample, such as to identify the presence or absence of the species, such as glucose or a protein. In some other embodiments, the qualitative model can identify the providence or source of the species, such as where the species was manufactured. An example of a quantitative model is one that can be used to determine a concentration of the species in the sample, such as a concentration of glucose or a protein.

A description of sample data sets for training a qualitative model is given below in Table 1. These data sets are simply examples of data sets on which the AutoML systems disclosed herein may be used, and the AutoML systems disclosed herein are not limited to use with these specific data sets but may be used with any suitable data set.

TABLE 1
Overview of summary statistics for the different data sets.

| | | Number of | Number of | |
|---|---|---|---|---|
| | Number of | Training | Validation | |
| Data set Name | Classes | Samples | Samples | Outliers |
| Data set #1 | 3 | 30 | 14 | No |
| Data set #2 | 2 | 42 | 30 | No |
| Data set #3 | 4 | 16 | 4 | No |
| Data set #4 | 3 | 246 | 191 | Yes |

Data set #1 was split into training and validation set using a stratified split. There are three classes, where class 0 appears to be significantly different from classes 1 and 2. The three classes are three types of Opadry film coating materials (orange, pink and yellow).

Data set #2 contains two classes: pure microcrystalline cellulose (MCC) and a mixture of MCC with carboxymethylcellulose. This is a challenging data set, for a few reasons. Firstly, MCC is present in both classes. Secondly, the validation data set was measured on a different batch than the training data set, and thirdly, the samples have different types of packaging, which may test the robustness of the models.

Data set #3: This data set contains four different classes of bovine serums and contains few samples. The validation data set was created by a stratified split of the training set. Two of the classes (1 and 2) are very similar to each other, as these are serums from the same type, but from different origins (Australian and Mexican). These classes are expected to be hard to distinguish. Because this data set is so limited in size, the random split for the validation set can have a significant influence on the results. In order to diminish this dependency on a random factor, the split is performed 10 times to create multiple random training/validation splits, and the tests are done on each of these splits.

Data set #4: This data set consists of three types of cell culture media and non-culture media samples, e.g. buffers (serving as outliers). The goal is to differentiate between these 3 types of culture media while rejecting outliers. Buffers will not be identified as any of the three media. This data set is larger than the other data sets. In the validation set, there are also many samples that are in none of the three training classes. These are expected to, during validation, be classified as outliers (−1). Furthermore, for this data set, the devices on which the samples have been measured are known. As discussed further below, this information may be used to investigate the transferability of the models between different measurement devices.

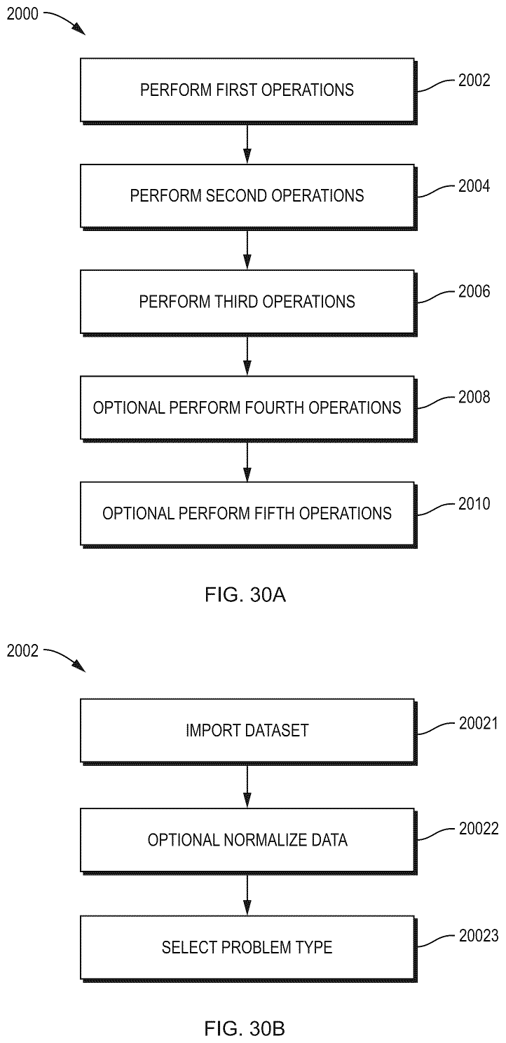

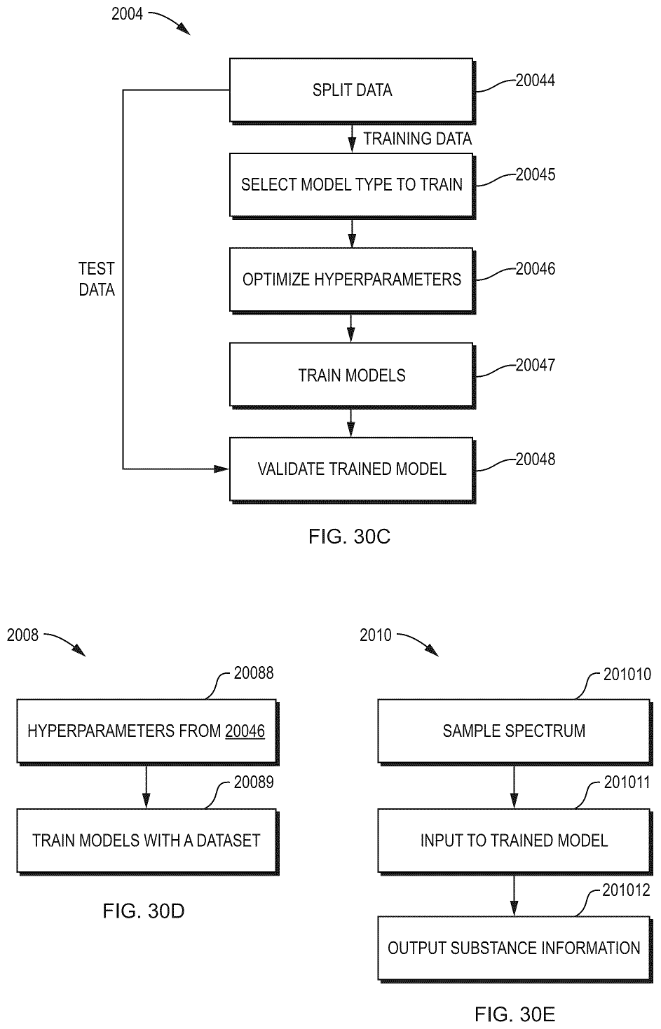

To improve model performance on the spectra, some pre-processing may be carried out. An example of a set of pre-processing operations are discussed herein; these operations may be modified, repeated, re-ordered, or omitted, and/or alternate operations included, as appropriate. For example, in embodiments in which data is generated by different spectroscopy devices (e.g., different handheld Raman spectrometers), standardization of the data arising from different devices may be performed as part of pre-processing efforts. In some embodiments, one or more of these pre-processing steps are hyperparameters such as can be optimized or found by methods described herein with reference to FIG. 30C.

A first step of pre-processing may be region selection. In some embodiments, not the entire spectrum is used, but only part of it. Using only a portion of the entire spectrum may have advantages in certain applications. For example, in some applications, the very high and very low wavenumber regions of the spectrum often feature a very low signal-to-noise ratio, so there is limited relevant information there, and training on noisy data may result in overfitting. In another example, in some applications, distinguishing between different substances can sometimes be based on very specific regions of the spectrum, where specific peaks can be observed. In such cases, the rest of the spectrum may be less relevant. In some embodiments, region selection is a hyperparameter. The start point, the endpoint, and number of selected regions may be optimized during hyperparameter optimization.

A second step of pre-processing may be an optional Standard Normal Variate (SNV) step. During SNV scaling, each spectral datapoint is scaled with a standard normal transformation. This is defined by the following equation:

$${x}_{i , SNV} = \frac{{x}_{i} - μ}{σ}$$

where xᵢ is the ith datapoint in a spectrum, y is the mean intensity of that spectrum, σ is the standard deviation of the intensity and x_{i,SNV} is the corrected value for xᵢ.

A third step of pre-processing may include data transformations, which in some embodiments may be a hyperparameter to optimized. For data transformations, the first hyperparameter is which transformation to perform. In some embodiments, the transformations that may be indicated by this hyperparameter may include baseline correction, Savitzy-Golay derivative, or no transformation at all. As an option for baseline correction, the adaptive iteratively reweighted Penalized Least Squares (airPLS) algorithm may be implemented, as described in Z.-M. Zhang, S. Chen and Y.-Z. Liang, “Baseline correction using adaptive iteratively weighted penalized least squares,” Analyst, vol. 135, no. 5, pp. 1138-1146, 2010. For Savitzy-Golay derivatives, Savitzy-Golay filters may be used in signal processing to smoothen local variations in input data; a window of a certain size is selected around a point, a polynomial of a given degree is fitted to the data in this window, and a derivative of this polynomial can be taken. For Savitzy-Golay derivatives, relevant hyperparameters may include the window size, the order of the fitted polynomial, and the order of the derivative.

A fourth step of pre-processing may include a mean center transformation. In some embodiments, a mean center transformation may be used as the final step of pre-processing. This centers a spectrum by subtracting the mean, making sure that the intensities are centered around 0.

In some low-data applications, such as chemometrics, some embodiments may include data augmentation. For example, noise may be added to the measurements using a particular noise model. An example noise model that may be used in chemometrics for a single spectral measurement may include three parts: read noise (which may originate from the inaccuracy in the charge-coupled display (CCD), and which may be normally distributed with fixed variance, and may be independently and identically distributed over the entire spectrum), thermal noise (which may be proportional to the exposure time, and may be independently and identically distributed over the entire spectrum), and shot noise (which may follow a Poisson distribution and may act as a heteroscedastic term, where the variance scales linearly with the intensity). Because of the heteroscedastic term in this noise model, the total noise sum is also heteroscedastic. Such a noise model may be used, for example, when separate measurement data, not averaged samples, are available.

In other embodiments, such a noise model may not be used. For example, in some embodiments, the samples used may be the result of doing multiple measurements, both bright (with excitation laser on) and dark (with excitation laser off). By subtracting dark measurements from bright ones, some correction for background effects may be achieved, and an average is then taken over multiple measurements.

In some embodiments, the samples (e.g., the samples that are the result of both bright and dark measurements, as discussed above) may be augmented with both homoscedastic and heteroscedastic noise with fixed pre-factors. For example, for the heteroscedastic noise, the variance may be scaled linearly with the intensity, as per the noise model. The noise is thus modelled simply as:

E_{homoscedastic}˜N(0,c₁);E_{heteroscedastic}˜N(0,c₂*I)

where E represents the different noise additions, N(0,σ²) is a normal distribution with mean 0 and variance σ², I is the local intensity and c₁ and c₂ are parameters to adjust the scale of the noise. The parameters c₁ and c₂ may be varied to determine the effects of augmentation for different noise levels. For low values of the parameters, the effects of augmentation may be so small that augmentation does not make any difference. As the values are increased, a point may be reached at which the noise becomes bigger than the differences in spectra between the different classes. This may result in worse performance for models with augmentation, compared to models without augmentation. Thus, in some embodiments, augmentation may not be used.

In some embodiments, the models used herein may be one-class classification models and multi-class classification models. One-class classification models are trained on only a single class of data and are used for the authentication task: determine whether a test sample is of the same class or not. Multi-class models are trained on data from n different classes, and have the goal of identification: to which of the n classes does a new test sample belong?

Models used in the Bayesian Optimization (BO) approaches disclosed herein may include principal components analysis (PCA), partial least squares (PLS) analysis, partial least squares discriminant analysis (PLSDA), support vector machines (SVM) (such as one-class SVM or multi-class SVM), random forests, gradient boosting, LASSO, or Elastic Net among others. A brief discussion of the use of these models is presented below.

PCA is an unsupervised statistical model, also known as singular value decomposition. It may learn to model a training data set by reducing all features of the samples to a few principal components, and then, on the testing data set, performs outlier detection on these principal components to find which samples belong to the same distribution as the training data set. This may be, therefore, a one-class classification model. The principal components can be computed by doing an eigendecomposition of the covariance matrix of the data. The eigenvectors with the highest corresponding eigenvalues then represent most of the variance in the data. This creates an orthogonal space in which the data can be represented. The main hyperparameter here is the number of eigenvectors k that are used to represent the data. Using more eigenvectors will give a higher explained variance of the model. Two statistical tests may then be used to identify outliers, the Hotelling T² test and Q-residuals test. The Hotelling T² test focusses on the distance of the sample in principal component space to the rest of the samples, while the Q-test focusses on the residuals between the sample and a reconstruction of the sample after being transformed to PC-space and back. These tests are complementary to each other, and if either of the tests classifies the sample as an outlier, in some embodiments, the systems disclosed herein may consider the sample an outlier. Because PCA is a dimensionality reduction algorithm, it can also be used as a pre-processing step for other models. The reduced dimensionality may lead to less overfitting on the training data.

PLS or Partial Least Squares regression (also known as “Projection to Latent Structures”) is a statistical method that generalizes and combines features from principal component analysis and multiple regression. It can be useful to predict a set of dependent variables from a very large set of independent variables (i.e., predictors). The goal of PLS regression is to predict Y from X and to describe their common structure. When Y is a vector and X is full rank, this goal could be accomplished using ordinary multiple regression. When the number of predictors is large compared to the number of observations, X is likely to be singular and the regression approach is no longer feasible (i.e., because of multicollinearity).

PLSDA is an adaption of PLS for categorical target variables. The procedure here is similar to PCA, in the sense that a dimensionality reduction is performed to obtain scores and loadings, but for PLS the decompositions are done in such a way that the covariance between predictors and targets is maximized in these scores. On the scores, a regression algorithm can be trained to predict the predictors. In PLSDA, the target variables are given as one-hot encoded vectors, for which the regression can be calculated.

The most basic SVM model is used for binary classification, where a selection is made between two classes. This basic model is linear and attempts to construct a hyperplane in feature space that maximally separates the training datapoints based on their class. Classification then involves checking on which side of the hyperplane a new testing point is and assigning the corresponding class. By using kernels, the SVM can become more powerful. These kernels allow for non-linear transformations, meaning that non-linear decision surfaces can be constructed. Each kernel has its own set of hyperparameters that allow for further tuning of the model. Whereas the basic SVM is for binary classification, it can be extended to also allow for multi-class classification. This may be done by splitting the multi-class problem into multiple binary classification problems, as discussed in K.-B. Duan and S. S. Keerthi, “Which is the best multiclass SVM method? An empirical study” in International workshop on multiple classifier systems, Berlin, Heidelberg, 2005. In some embodiments, the SVM may be preceded by a PCA decomposition to prevent or limit overfitting. An SVM can also be used as a one-class model for outlier detection. In this case, the SVM is trained on a data set that only contains samples of the class that are to be identified. A minimal envelope is then constructed as hyperplane around this data set in feature space. Any new test point outside of the envelope is classified as an outlier. This model can be used as a stand-alone one-class model for authentication, or as an outlier model, in addition to a multi-class classifier. In some embodiments, for the one-class SVM, no dimensionality reduction may be used. Such one-class SVMs may perform well on high-dimensional data in the systems disclosed herein without the use of PCA for feature extraction.

A random forest (RF) model (e.g., as discussed in L. Breiman, “Random forests,” Machine Learning, vol. 45, no. 1, pp. 5-32, 2001) is a type of ensemble model. The RF is created by randomly generating multiple decision tree models for classification. These decision trees can be generated in multiple ways, but this generally consists of splitting the data based on a randomly selected feature and repeating this process. This forms a tree-like structure. Such a single tree may be susceptible to overfitting. However, when the trees are assembled into an RF, the complete ensemble may be more robust to overfitting. The assembling consists of having each tree ‘vote’ for the class to be chosen, and the class that gains the most votes (is predicted by most trees) will be the final prediction of the RF. In some embodiments, preceding the random forest with a PCA decomposition may help to prevent overfitting on the training data even further. Therefore, this may be implemented as the first step in the model, with the RF generation/classification afterwards.

Like random forests, gradient boosting is based on model ensembles, as discussed in J. Friedman, “Greedy function approximation: a gradient boosting machine,” Annals of statistics, pp. 1189-1232, 2001. A gradient boosting model is built in iterative fashion. For some machine learning tasks, the first iteration starts with a very simple model (e.g., a decision tree). Gradient boosting then may include finding the residuals between the predictions that this model makes and the true target values of the training set, and fitting an additional estimator to these residuals, in order to correct the first one. This process then repeats for a pre-set number of iterations. The term gradient boosting originates from the observation that the model residuals are proportional to the negative gradient of the loss function. Therefore, this process may minimize the loss function. Gradient boosting may also be preceded by PCA dimensionality reduction in some embodiments.

LASSO or Least Absolute Shrinkage and Selection Operator is a statistical formula for the regularization of data models and feature selection. It is used over regression methods for a more accurate prediction. The model uses shrinkage, where data values are shrunk towards a central point as the mean. The lasso procedure encourages simple, sparse models (i.e. models with fewer parameters). This particular type of regression is well-suited for models showing high levels of multicollinearity or for automating certain parts of model selection, such as variable selection/parameter elimination.

The Elastic Net method overcomes the limitations of the LASSO method which uses a penalty function based on:

∥β∥₁=Σⱼ₌₁^{p}|βⱼ|

Use of this penalty function has several limitations (Zou, Hui; Hastie, Trevor (2005). “Regularization and Variable Selection via the Elastic Net”. Journal of the Royal Statistical Society, Series B. 67 (2): 301-320.) For example, in the “large p, small n” case (high-dimensional data with few examples), the LASSO selects at most n variables before it saturates. Also if there is a group of highly correlated variables, then the LASSO tends to select one variable from a group and ignore the others. To overcome these limitations, the elastic net adds a quadratic part (∥β∥²) to the penalty, which when used alone is ridge regression (also known as Tikhonov regularization). The estimates from the elastic net method are defined by:

β≡argmin(∥y−Xβ∥²+λ₂∥β∥²+λ₁∥β∥₁.

The quadratic penalty term makes the loss function strongly convex, and it therefore has a unique minimum. The elastic net method includes the LASSO and ridge regression: in other words, each of them is a special case where λ₁=λ, λ₂=0 or λ₁=0, λ₂=λ. Meanwhile, the naive version of elastic net method finds an estimator in a two-stage procedure: first for each fixed λ₂ it finds the ridge regression coefficients, and then does a LASSO type shrinkage. This kind of estimation incurs a double amount of shrinkage, which leads to increased bias and poor predictions. To improve the prediction performance, sometimes the coefficients of the naive version of elastic net is rescaled by multiplying the estimated coefficients by (1+λ₂).

As noted above, the AutoML systems disclosed herein may utilize Bayesian Optimization (BO), as discussed in P. Frazier, “A tutorial on Bayesian Optimization,” arXiv preprint arXiv:1807.02811, 2018. This system allows for the quick optimization of functions over multidimensional parameter spaces. Generally, the goal of optimization is to minimize some cost function ƒ(x), where the cost function is usually very time-consuming to evaluate:

$${min}_{x ∈ X} f ( x )$$

Here, x is a parameter for the function, or a set of parameters, and X is the search space of all possible parameter values. For example, x can be values for a hyperparameter. Where several hyperparameters are used, the function has several x variables and the search space X is multidimensional, with the number of x variables equal to the dimension. A naïve way of doing this minimization is making a uniform grid of parameter combinations, evaluating ƒ for all these combinations and selecting a minimal value. This is, however, sub-optimal for several reasons, including that large parts of the search space could lead to very bad values for the cost function (and therefore as little as possible time should be spent exploring this part of the search space, which a uniform grid does not take into account), and the actual minimal value most likely will not coincide with any of the grid points for continuous domains (therefore the optimal parameter combination is unlikely to be found).

Bayesian Optimization aims to work around these issues by choosing which points in the search space to evaluate in an informed way. To do this, an estimate is made of the expected cost value for the entirety of the search space, with corresponding uncertainty, by fitting a Gaussian process to all the points in the search space that have so far been evaluated. An acquisition function that is faster to evaluate than ƒ(x) is then used to determine which point in the search space to evaluate next. The acquisition function may include two complementary terms: one for exploration, and one for exploitation. Exploration means that parts of the search space that have yet to be explored are more interesting, as this could lead to new, optimal solutions. Exploitation is more local behavior, where focus is put on some area that has already proven to give good solutions, to find the optimal solution in this area. After selecting a new training point with the acquisition function, the target function is evaluated for this point. The Gaussian process is then refitted to incorporate this new point, and the process starts again.

In some embodiments, the leave-one-out cross-validation score of a model on a training data set is used as a target function, and an objective may be to find the combination of hyperparameters that minimizes this score. For a qualitative model, the score is either the percentage of misclassified samples in the cross-validation test sets, or the cross-entropy between the confidence of predictions and the actual classes for a multi-class problem. For quantitative models, the normalized mean squared error (MSE) is calculated per substance and then averaged over all substances for the cost function. The normalization constant is the variance in the measured feature (e.g., concentration) of a substance taken over the whole training set—i.e., the normalization constants are calculated before the train/test split. For each predicted quantity the MSE is taken between the predictions for each sample compared to the reference values of each sample. These normalized MSEs per substance are then averaged together to a single cost value that is to be minimized.

In some embodiments, systems using BO for AutoML may utilize the SMAC3 Python library, as discussed in M. Lindauer, K. Eggensperger, M. Feurer, A. Biedenkapp, D. Deng, C. Benjamins, R. Sass and F. Hutter, “SMAC3: A Versatile Bayesian Optimization Package for Hyperparameter Optimization,” arXiv:2109.09831, 2021. This efficiently implements the BO procedure and leaves a lot of flexibility to implement further authentication and identification algorithms. Another advantage to using SMAC is the ease with which it allows for conditional parameters. Conditional parameters are hyperparameters that are only active based on some condition for other parameters. An inactive parameter will be excluded from the search space, limiting the amount of computational power that is required to effectively explore the search space. There may be a lot of conditional parameters in an AutoML system: for example, the window size of a Savitzy-Golay derivative is only relevant when such a derivative is performed. Another example is the degree of an SVM, as this parameter is dependent on the kernel parameter, and should only be active when a polynomial kernel is used. Furthermore, there are several methods of gaining a speed increase in SMAC, such as aggressive racing, hyperband, and parallel evaluations, any of which may be used in the systems disclosed herein. In some embodiments, SMAC may be run on a Linux distribution through the Windows Subsystem for Linux (WSL). In some embodiments, the Bayesian Optimization is implemented using Optuna, which is a commercial hyperparameter optimization framework to automate hyperparameter search (www.https://optuna.org/accessed Apr. 11, 2023).

In other embodiments, alternative approaches to hyperparameter optimization may be used. For example, in some embodiments, genetic algorithms may be used. Genetic algorithms try to model the ‘survival-of-the-fittest’ evolutionary model, as discussed in J. R. Koza and R. Poli, “Genetic programming,” in Search methodologies, Boston, MA, Springer, 2005, pp. 127-164. A generation, consisting of many models, is randomly initialized, with a different set of hyperparameters for each of the models. The evolutionary process then begins. Models that score poorly, are discarded. Models that score well are passed down to the next generation. This generation is subsequently extended by combining multiple well-scoring models (crossover) and by creating new models for which the parameters are slightly altered from one of the well-performing models (mutation). This process then continues for a given number of generations, resulting in a population of well-performing models in the final generation. One downside of genetic programming is that many different models are optimized in each generation, while the vast majority of these are not used, as discussed in F. Hutter, L. Kotthoff and J. Vanschoren, Automated Machine Learning: Methods, Systems, Challenges, Springer, 2019. This can make the process slower than the Bayesian approach discussed above.

In some embodiments, deep learning may be used for hyperparameter optimization. Neural networks contain a lot of hyperparameters related to their architectures, and the search for an optimal network is called Neural Architecture Search (NAS). There are several approaches that implement NAS, such as the systems discussed in L. Zimmer, M. Lindauer and F. Hutter, “Auto-Pytorch Tabular: Multi-Fidelity MetaLearning for Efficient and Robust AutoDL,” arXiv preprint, 2020 and H. Jin, Q. Song and X. Hu, “Auto-keras: An efficient neural architecture search system,” in 25th ACM SIGKDD International Conference on Knowledge Discovery & Data Mining, 2019. Deep neural networks are powerful enough to model very subtle differences in data, but they may quickly overfit on small data sets, and thus may not be a good match for chemometrics applications with small data sets. In some embodiments, neural networks may be used as a feature engineering system in later stages of an AutoML system, as discussed further below.

Example results for particular embodiments of the AutoML systems on various ones of the data sets disclosed herein are discussed below. Qualitative model examples are presented first, followed by examples for quantitative models.

For the multi-class classification models, results are presented as confusion matrices, which show the combination of actual class and predicted class, summed over all samples. The one-class classification results are shown in tables, as separate models are trained to identify each class in the data set. The class on which the model is trained is indicated as the target class. The model is tested against each of the classes in the testing data set (which includes the target class). If the test class is the same as the target class, all samples should be identified. None of the samples should be identified if the test class is not the same as the target class.

For Data set #1, the tested identification models all obtain a 100% accuracy on the validation data set, and most do so after only a few iterations of the Bayesian Optimization procedure. This means that an excellently working model may be achieved within a time span of seconds to minutes. Note that the validation data set is used in no way during training and optimization, so there is no overfitting or data leakage during these procedures. The (trivial) confusion matrix representing these results is shown in FIG. 2.

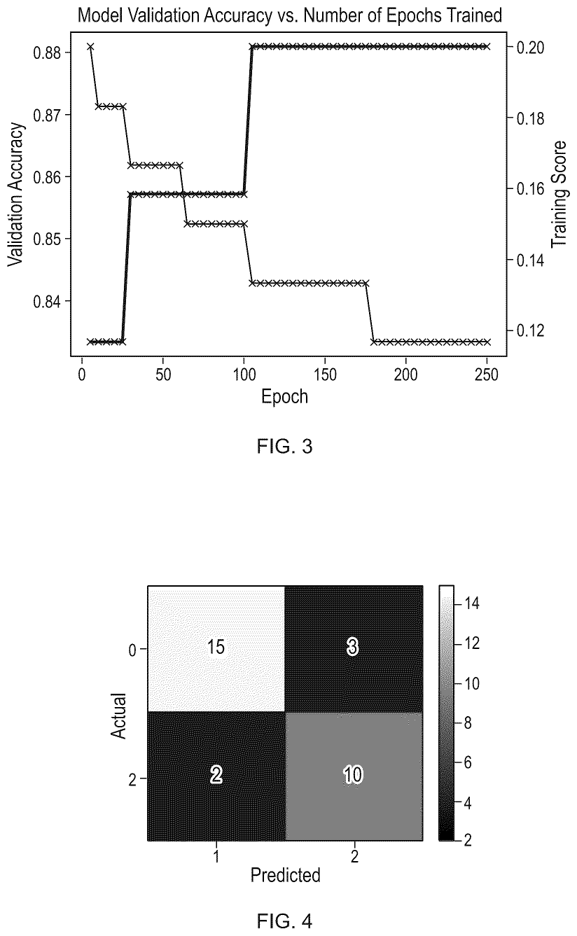

The performance of the tested one-class classification models on Data set #1 is lower than the performance of the identification models. For one-class SVM, the epoch-loss curve is given in FIG. 3. An epoch is one iteration of the Bayesian optimization procedure. The accuracy reaches around 88%. This also shows that in this case, minimizing the training score has the desired effect of increasing validation accuracy. The validation accuracy is calculated by training multiple one-class models, one for each class in the data set, and averaging the results of these models. FIG. 3 represents the best training score and validation accuracy after different amounts of optimization iterations (epochs). The validation accuracy is obtained by taking the configuration that has the best training score so far. Note that score should be minimized.

The class-specific results for Data set #1 are given in Table 2 for one-class SVM and in Table 3 for a PCA model. This table should be read in the following way: because these are one-class models, a separate model is trained for each class in the training set, indicated by “Target Class.” This is subsequently tested on all samples from the different test classes. If the test class is the same as the target class, the goal is to identify all the samples. If the classes are different, none should be identified. The overall accuracy is calculated by adding the number of correct predictions for each of the target classes and dividing by the total number or predictions made. For both one-class models, false negatives are the reason for the lower accuracy, rather than false positives. It seems that the optimization procedure finds mostly models that are slightly too sensitive, even after tuning the relevant hyperparameters. However, especially for the PCA model, the average accuracy is acceptable.

TABLE 2
One-class SVM results on Data set #1. Overall accuracy: 88.1%.

| Target | Test | | |
|---|---|---|---|
| Class | Class | Identified | Accuracy |
| 0 | 0 | 2/5 | 40% |
| | 1 | 0/4 | 100% |
| | 2 | 0/5 | 100% |
| 1 | 0 | 0/5 | 100% |
| | 1 | 3/4 | 75% |
| | 2 | 0/5 | 100% |
| 2 | 0 | 0/5 | 100% |
| | 1 | 0/4 | 100% |
| | 2 | 4/5 | 80% |

TABLE 3
PCA results on Data set #1. Overall accuracy: 97.6%.

| Target | Test | | |
|---|---|---|---|
| Class | Class | Identified | Accuracy |
| 0 | 0 | 4/5 | 80% |
| | 1 | 0/4 | 100% |
| | 2 | 0/5 | 100% |
| 1 | 0 | 0/5 | 100% |
| | 1 | 4/4 | 100% |
| | 2 | 0/5 | 100% |
| 2 | 0 | 0/5 | 100% |
| | 1 | 0/4 | 100% |
| | 2 | 5/5 | 100% |

For Data set #2, most tested identification algorithms again find an accuracy of 100%. Only for the multi-class SVM, this is slightly lower at 83%. The confusion matrix in FIG. 4 (representing the classification results of an SVM after Bayesian optimization on Data set #2) shows that there are some misclassifications, but overall performance is still good.

TABLE 4
One-class SVM results on Data set #2. Overall accuracy: 80.0%

| Target | Test | | |
|---|---|---|---|
| Class | Class | Identified | Accuracy |
| 0 | 0 | 10/18 | 55.6% |
| | 1 | 0/12 | 100% |
| 1 | 0 | 0/18 | 100% |
| | 1 | 8/12 | 66.7% |

TABLE 5
PCA results on Data set #2. Overall accuracy: 91.7%

| Target | Test | | |
|---|---|---|---|
| Class | Class | Identified | Accuracy |
| 0 | 0 | 15/18 | 83.3% |
| | 1 | 0/12 | 100% |
| 1 | 0 | 0/18 | 100% |
| | 1 | 10/12 | 83.3% |

For the one-class classification models, the results are given for Data set #2 in Table 4 for SVM and Table 5 for PCA. The models achieve similar performances, but the SVM has a few more false negatives than the PCA tests. This could be due to the SVM being a more powerful model and picking up on the differences between the training batches and testing batches. With an accuracy of 91.7%, the PCA model performs well.

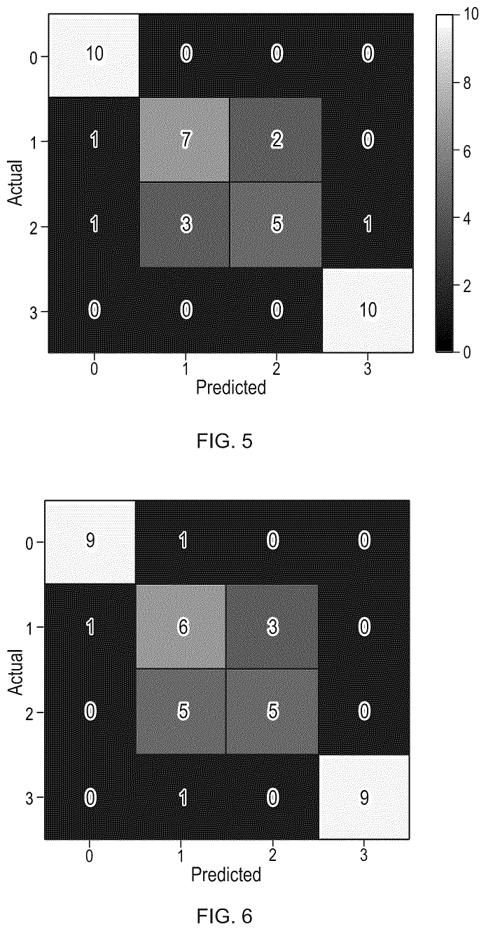

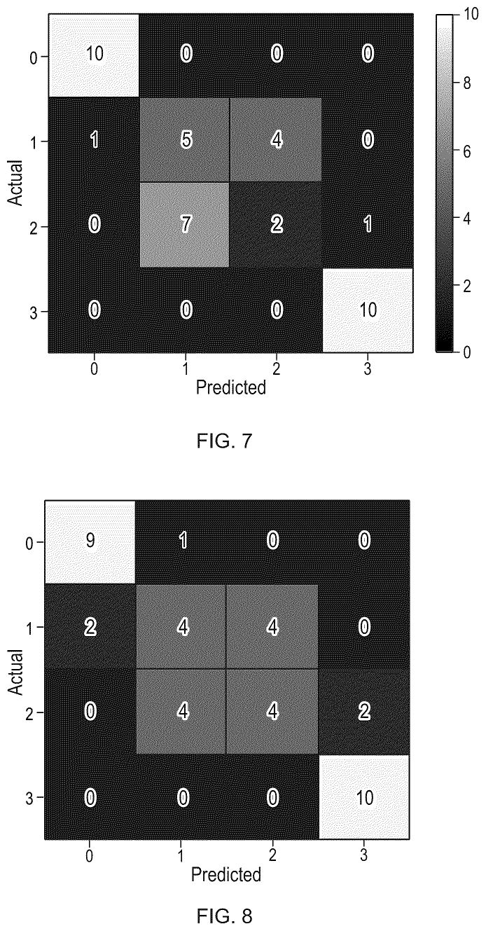

Due to the very limited size of Data set #2, there is a significant variance in experiments depending on the train/test split. To counteract this, the train/test split is performed ten times, and all experiments are repeated on each split. This reduces the dependency on the single train/test split, as this can cause large differences in performance. The most challenging aspect of this data set is distinguishing between classes 1 and 2, the bovine serums coming from Australia and Mexico. This is clearly visible in all results for the multi-class classification models (FIGS. 5-8). In particular, FIG. 5 represents Random Forest results on Data set #3 (with an 80% average accuracy), FIG. 6 represents XGBoost results on the Data set #3 (with a 72.5% average accuracy), FIG. 7 represents PLSDA results on the Data set #3 (with a 67.5% average accuracy), and FIG. 8 represents SVM results on Data set #3 (with a 67.5% average accuracy). Overall performance is quite good, but these two classes are often confused by the model. Random Forest has the best performance here, reaching 80%.

TABLE 6
One-class SVM results for Data set #3. Overall accuracy: 78.8%.

| Target | Test | | |
|---|---|---|---|
| Class | Class | Identified | Accuracy |
| 0 | 0 | 5/10 | 50% |
| | 1 | 1/10 | 90% |
| | 2 | 0/10 | 100% |
| | 3 | 0/10 | 100% |
| 1 | 0 | 2/10 | 80% |
| | 1 | 2/10 | 20% |
| | 2 | 4/10 | 60% |
| | 3 | 0/10 | 100% |
| 2 | 0 | 0/10 | 100% |
| | 1 | 4/10 | 60% |
| | 2 | 4/10 | 40% |
| | 3 | 0/10 | 100% |
| 3 | 0 | 0/10 | 100% |
| | 1 | 0/10 | 100% |
| | 2 | 0/10 | 100% |
| | 3 | 6/10 | 60% |

TABLE 7
PCA results for Data set #3. Overall accuracy: 76.9%

| Target | Test | | |
|---|---|---|---|
| Class | Class | Identified | Accuracy |
| 0 | 0 | 8/10 | 80% |
| | 1 | 3/10 | 70% |
| | 2 | 1/10 | 90% |
| | 3 | 0/10 | 100% |
| 1 | 0 | 3/10 | 70% |
| | 1 | 5/10 | 50% |
| | 2 | 5/10 | 50% |
| | 3 | 0/10 | 100% |
| 2 | 0 | 2/10 | 80% |
| | 1 | 3/10 | 70% |
| | 2 | 7/10 | 70% |
| | 3 | 0/10 | 100% |
| 3 | 0 | 0/10 | 100% |
| | 1 | 0/10 | 100% |
| | 2 | 1/10 | 90% |
| | 3 | 9/10 | 90% |

The one-class models exhibit similar behavior on Data set #2, where samples from classes 1 and 2 are often confused: models trained on class 1 have around the same rate of positives on class 2 and vice versa. There is also some confusion with class 0.

The tested models are able to readily distinguish the training classes in Data set #4. All identification algorithms obtain 100% accuracy on these classes. However, when outliers are included, the task becomes more complex. As noted above, the validation data set of Data set #4 contains a lot of outliers. These samples are from some random substance that is not included in the training data. The models should reject these samples. For the multi-class classification models, this is a complex problem, as by definition the outliers are not included in the training data. This means that there is no way to incorporate any information on what to expect from the outliers in the models, and thus outlier detection may not be optimized during the Bayesian Optimization approach. Therefore, in some embodiments, only general models or statistical tests are used.

However, for the one-class models, outlier detection is a natural part of model application. As they are simply identifying whether a test sample is the target class or not, it does not matter if the data includes an outlier or is one of the other training classes; the model should reject this sample. The results for SVM and PCA on Data set #4 are given in Table 8 and Table 9, respectively. Especially for the SVM, performance is good, with an overall accuracy of 98.4%. Almost all outliers are identified correctly, and the model easily identifies the training classes as well. For PCA, results are still good, at an accuracy over 90%, but there are some more misclassifications in the form of both false positives and false negatives.

TABLE 8
SVM results for Data set #4. Overall accuracy: 98.4%.

| Target | Test | | |
|---|---|---|---|
| Class | Class | Identified | Accuracy |
| 0 | Outlier | 5/117 | 95.7% |
| | 0 | 29/33 | 87.9% |
| | 1 | 0/22 | 100% |
| | 2 | 0/19 | 100% |
| 1 | Outlier | 0/117 | 100% |
| | 0 | 0/33 | 100% |
| | 1 | 22/22 | 100% |
| | 2 | 0/19 | 100% |
| 2 | Outlier | 0/117 | 100% |
| | 0 | 0/33 | 100% |
| | 1 | 0/22 | 100% |
| | 2 | 19/19 | 100% |

TABLE 9
PCA results for Data set #4. Overall accuracy: 90.9%.

| Target | Test | | |
|---|---|---|---|
| Class | Class | Identified | Accuracy |
| 0 | Outlier | 14/117 | 88.0% |
| | 0 | 18/33 | 54.5% |
| | 1 | 0/22 | 100% |
| | 2 | 0/19 | 100% |
| 1 | Outlier | 3/117 | 97.4% |
| | 0 | 0/33 | 100% |
| | 1 | 21/22 | 95.5% |
| | 2 | 4/19 | 78.9% |
| 2 | Outlier | 6/117 | 94.9% |
| | 0 | 0/33 | 100% |
| | 1 | 8/22 | 63.6% |
| | 2 | 18/19 | 94.7% |

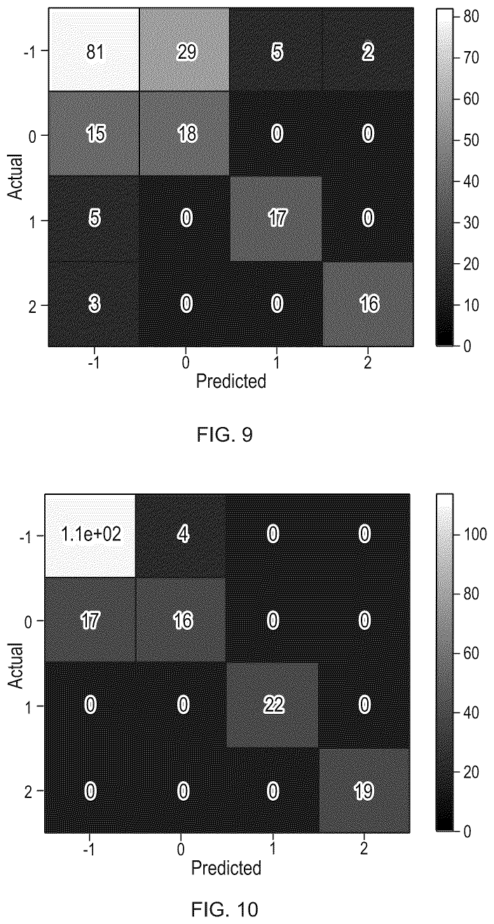

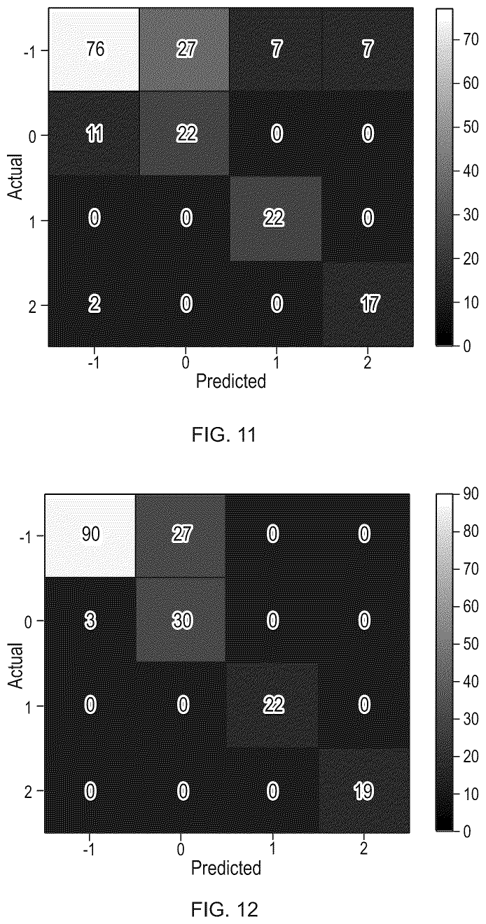

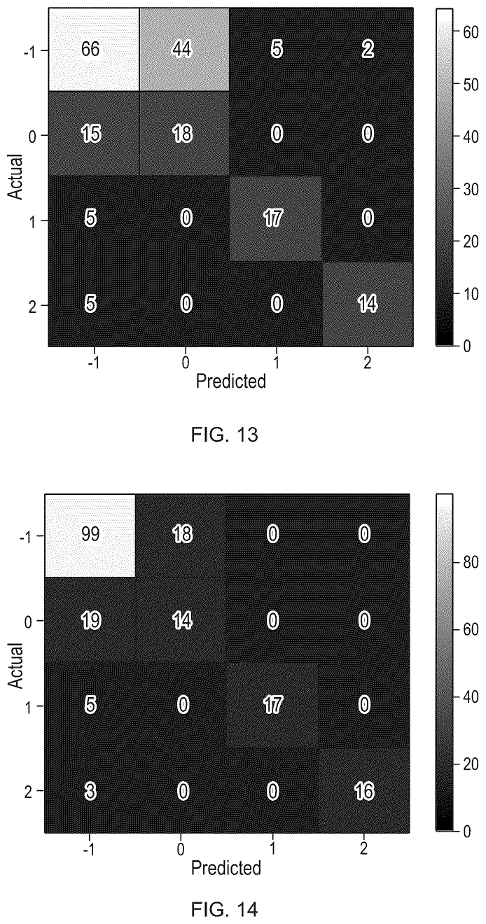

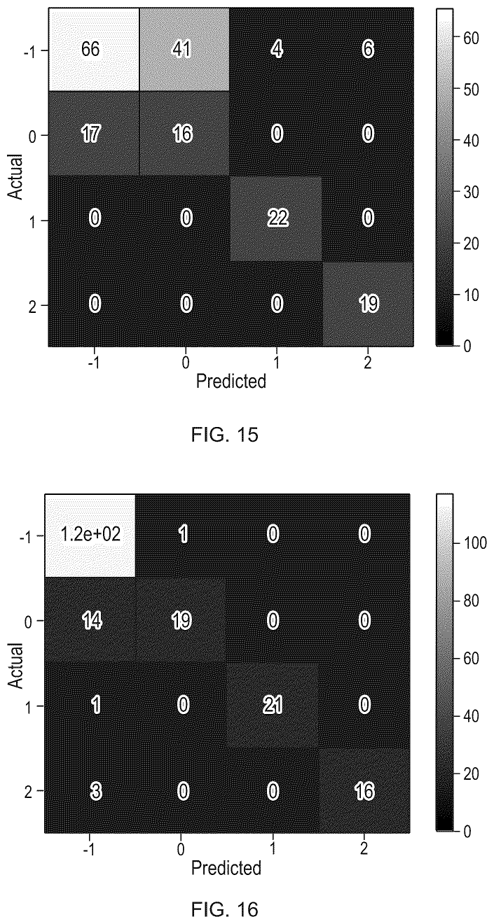

For the multi-class classification models, outlier detection is not such a natural step in the normal prediction process, and the approaches disclosed herein may take a number of additional steps to improve outlier detection. The methods for improved outlier detection may include: (1) do the statistical Hotelling T² and Q residual tests on a dimensionality reduction step, as described above, to the PLS latent projection or to the PCA dimensionality reduction that precedes all the other multi-class classification models; and/or (2) leverage a one-class classification model to act as a first step in prediction. In the latter method, the one-class classification model is trained on all training data (which contains multiple classes) and determines whether a test sample belongs to this distribution. If it does, the classification is performed in the next step, to determine the exact class for this sample, if it does not belong to the distribution it is rejected as an outlier. The one-class SVM may work well for this in some embodiments. Note that for both outlier detection methods, it holds that outlier detection cannot be optimized in the BO procedure, as there are no outliers in the training set for multi-class classification. Therefore, for the best configuration that is found by the model, it makes no difference which outlier method is used during the optimization procedure. The results for all classification models, for both options, are given in FIGS. 9-16. In particular, FIG. 9 represents the results for the RF+Hotelling/Q for outliers classification model (with a 69.1% total accuracy), FIG. 10 represents the results for the RF+1-class SVM for outliers classification model (with a 89.0% total accuracy), FIG. 11 represents the results for the PLSDA+Hotelling/Q for outliers classification model (with a 71.7% total accuracy), FIG. 12 represents the results for the PLSDA+1-class SVM for outliers classification model (with an 84.3% accuracy), FIG. 13 represents the results for the SVM+Hotelling/Q for outliers classification model (with a 60.2% total accuracy), FIG. 14 represents the results for the SVM+1-class SVM for outliers classification model (with a 76.4% total accuracy), FIG. 15 represents the results for the XGB+Hotelling/Q for outliers classification model (with a 64.4% total accuracy), and FIG. 16 represents the results for the XGB+1-class SVM for outliers classification model (with a 90.1% total accuracy). For all models, the one-class SVM has a better outlier-accuracy than the combination of Hotelling T² and Q test. The one-class SVM provides significantly less false negatives, and in three out of four cases we also see less false positives. With accuracies in the range of 75% to 90%, the one-class SVM performs well. For the samples that are not actual outliers, nor classified as outliers, the classification models achieve 100% classification accuracies. Comparing all accuracies, the one-class SVM appears to be the best model for Data set #4.

Another feature of Data set #4 is that there is available information on which handheld device is used to measure each spectrum. For the whole data set, seven different devices have been used. To test how well a model transfers from one set of devices to another, a test is run in which the training set only contains data from four devices, and the validation set contains all data from the other three devices, as well as the outliers.

TABLE 10
Transferability of SVM one-class model. Overall accuracy: 85.6%

| Target | Test | | |
|---|---|---|---|
| Class | Class | Identified | Accuracy |
| 0 | Outlier | 4/117 | 96.6% |
| | 0 | 14/51 | 27.5% |
| | 1 | 0/73 | 100% |
| | 2 | 0/62 | 100% |
| 1 | Outlier | 0/117 | 100% |
| | 0 | 0/51 | 100% |
| | 1 | 34/73 | 46.6% |
| | 2 | 0/62 | 100% |
| 2 | Outlier | 0/117 | 100% |
| | 0 | 0/51 | 100% |
| | 1 | 0/73 | 100% |
| | 2 | 11/62 | 17.7% |

TABLE 11
Transferability of PCA one-class model. Overall accuracy: 74.81%

| Target | Test | | |
|---|---|---|---|
| Class | Class | Identified | Accuracy |
| 0 | Outlier | 37/117 | 68.4% |
| | 0 | 30/51 | 58.8% |
| | 1 | 12/73 | 83.6% |
| | 2 | 5/62 | 91.9% |
| 1 | Outlier | 16/117 | 86.3% |
| | 0 | 2/51 | 100% |
| | 1 | 35/73 | 47.9% |
| | 2 | 23/62 | 62.9% |
| 2 | Outlier | 12/117 | 89.7% |
| | 0 | 0/51 | 100% |
| | 1 | 25/73 | 65.8% |
| | 2 | 24/62 | 38.7% |

For the one-class models, the results are given in Table 10 and Table 11. There is a significant performance drop with respect to the non-transferred results. Overall accuracy remains quite high, especially for the one-class SVM, due to the high number of true negatives that this model finds, but the false negative rate is also quite high. The PCA model, similarly to before, finds a lot of false positives as well.

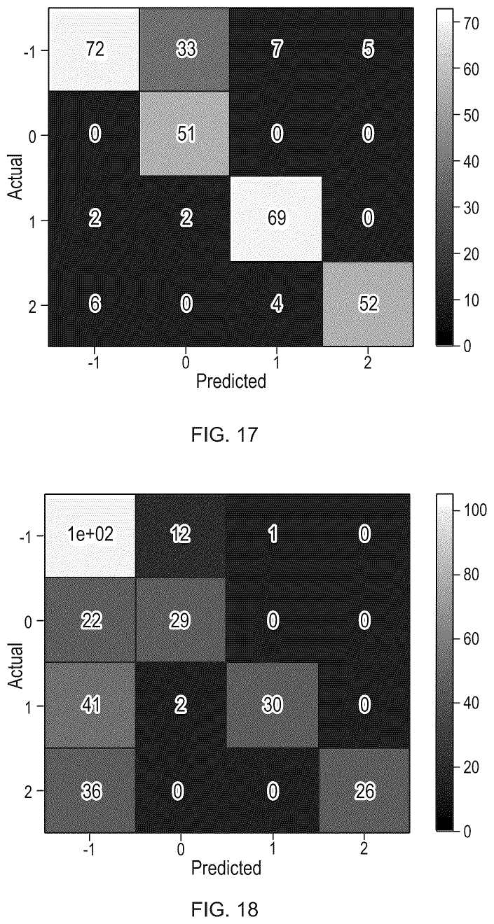

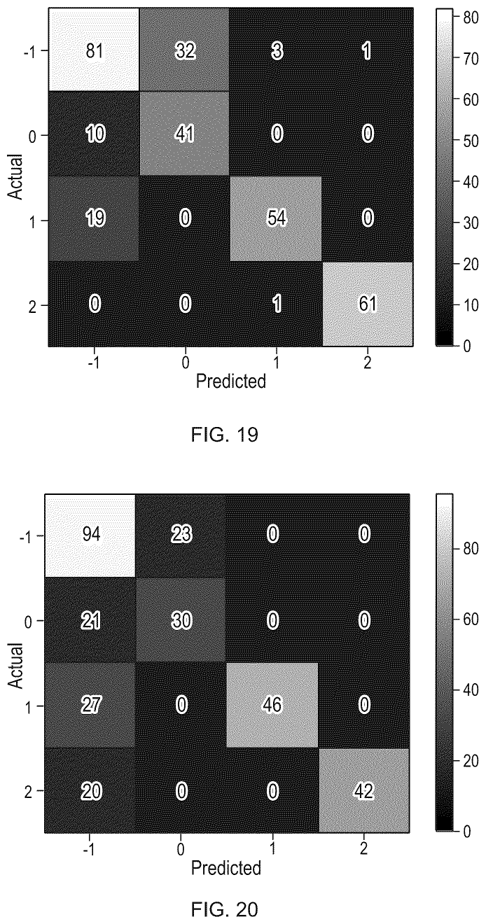

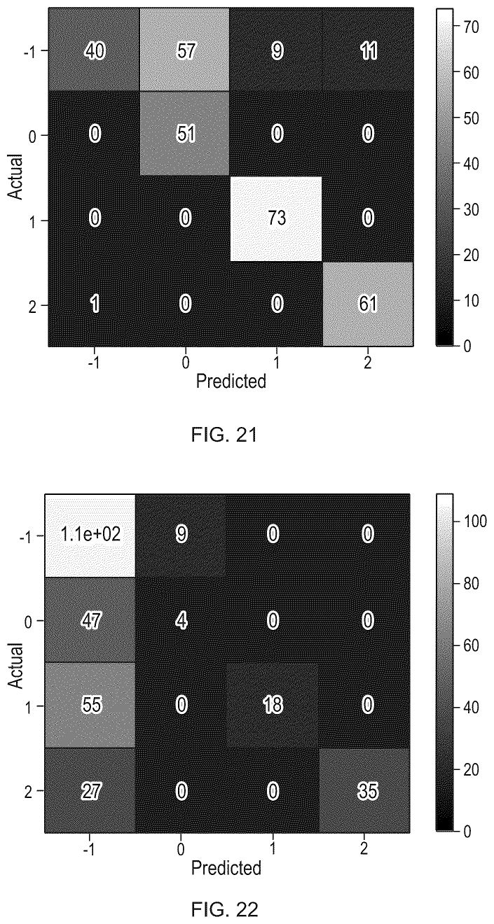

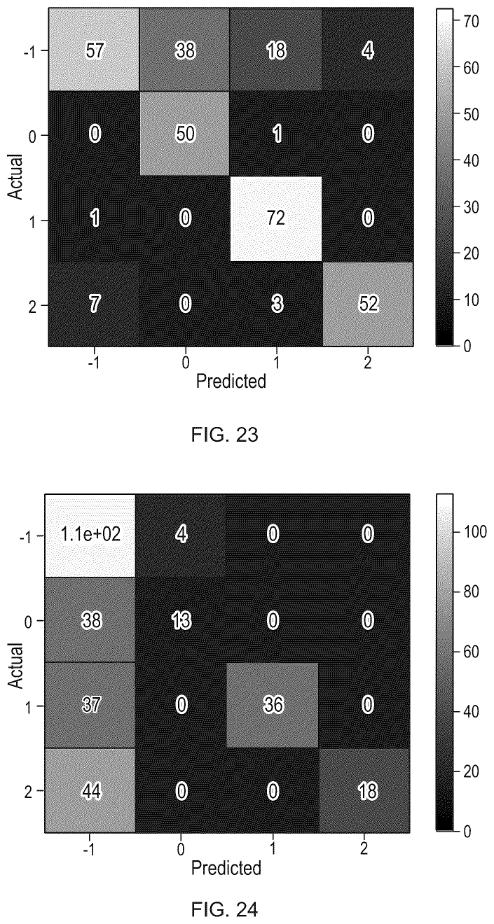

For the classification models, the results are depicted in FIGS. 17-24. In particular, FIG. 17 represents the results for the Random Forest+T2/Q transferability classification model (with 80.5% total accuracy), FIG. 18 represents the results for the Random Forest+1-class SVM transferability classification model (with 62.4% total accuracy), FIG. 19 represents the results for the PLSDA+T2/Q transferability classification model (with 78.2% accuracy), FIG. 20 represents the results for the PLSDA+1-class SVM transferability classification model (with 70.0% accuracy), FIG. 21 represents the results for the SVM+T2/Q transferability classification model (with 74.3% accuracy), FIG. 22 represents the results for the SVM+1-class SVM transferability classification model (with 54.5% accuracy), FIG. 23 represents the results for the XGB+T2/Q transferability classification model (with 76.2% accuracy), and FIG. 24 represents the results for the XGB+1-class SVM transferability classification model (with 59.4% accuracy). Although there are a couple of misclassifications between the classes here and there, the main point of attention is in the outlier detection, again. There is a clear distinction between using Hotelling/Q-tests and using the one-class SVM. The statistical tests find a lot of false negatives for outlier prediction, whereas the one-class SVM finds mostly false positives. It is worth noting that the false negatives generally look very much like the training samples and that is not surprising that they are not detected by the algorithm. Depending on the use case, false negatives might be more desirable than false positives, or the other way around. Although there are some misclassifications in the outlier detection, the multi-class classification still works very well after transferring.

For qualitative models, spectra measured from samples that include a known quantity such as the concentration of one or more species are used. In some embodiments this can be from samples in bioreactors. Table 12 lists conditions for bioreactors used in generating data sets for a quantitative model. Glucose concentration is monitored by a standard method while at approximately the same time a Raman spectra of the bioreactor solution is measured. The standard method for glucose concentration measurement can be any reliable and known method such as a chromatography method (e.g., HPLC) or Electrochemical methods. In this implementation, an electrochemical method was used. The number of spectra and glucose measurements is indicated in Table 12. Table 13 shows a subset of the measured glucose concentration, specifically, the first 10 values of Run 2 from Table 12 in a first reactor and a second reactor. In total 500 spectra were collected.

TABLE 12
CHO is Chinese Hamster Ovary cells: ExpiCHO-S ™ Cells (Thermo Fisher Scientific inc Cat # A29132);
SPM is ExpiCHO ™ Stable Production Medium (Thermo Fisher Scientific inc. Cat # A3711001); and BPM is Balance CD Production Media.

| | Cell | | Feed | Feed | Feed Media | Glucose | Run | Reactor | Number of | Number of |
|---|---|---|---|---|---|---|---|---|---|---|
| Run # | Line | Initial Media | Media 1 | Media 2 | Type | Feeding Type | Mode | Type | Reactors | Spectra |
| 2 | CHO | SPM + 6 mM | EFC 2X 3% | None | Bolus | Bolus | Fed Batch | 5L Glass | 2 | 89 |
| | | L-Glutamine + | Weigth/Day | | | | | | | |
| | | 2 g/L pluronic | | | | | | | | |
| 3 | CHO | BPM + 6 mM | Cell Boost | Cell Boost | Bolus | Bolus | Fed Batch | 500L Dyna | 1 | 70 |
| | | L-glutamine + | 7a | 7b | | | | Drive | | |
| | | 1 g/L pluronic | | | | | | | | |
| 4 | CHO | SPM + 6 mM | EFC 2X 3% | None | Bolus | Bolus | Fed Batch | 5L Glass | 2 | 89 |
| | | L-Glutamine + | Weight/Day | | | | | | | |
| | | 2 g/L pluronic | | | | | | | | |
| 6 | CHO | SPM + 6 mM | EFC 2X 3% | None | Bolus | Bolus | Fed Batch | 500L Dyna | 1 | 104 |
| | | L-Glutamine + | Weight/Day | | | | | Drive | | |
| | | 2 g/L pluronic | | | | | | | | |
| 7 | CHO | SPM + 6 mM | EFC 2X 3% | None | Bolus | Bolus | Fed Batch | 5L Glass | 2 | 49 |
| | | L-Glutamine + | Weight/Day | | | | | | | |
| | | 2 g/L pluronic | | | | | | | | |
| 8 | CHO | SPM + 6 mM | Continuous, | None | Continuous | Continuous/ | Fed Batch | 5L Glass | 2 | 62 |
| | | L-Glutamine + | EFC 2X 3% | | | Bolus | | | | |
| | | 2 g/L pluronic | Weight/Day | | | | | | | |
| 9 | CHO | SPM + 6 mM | EFC 2X 3% | None | Bolus | Bolus | Fed Batch | 500L Dyna | 1 | 13 |
| | | L-Glutamine + | Weight/Day | | | | | Drive | | |
| | | 2 g/L pluronic | | | | | | | | |
| 11 | CHO | SPM + 6 mM | Continuous, | None | Continuous | Continuous/ | Fed Batch | 5L Glass | 2 | 24 |
| | | L-Glutamine + | EFC 2X 3% | | | Bolus | | | | |
| | | 2 g/L pluronic | Weight/Day | | | | | | | |

TABLE 13
glucose concentrations Run 2, first 10 spectra
in reactor 1 and first 10 spectra in reactor 2.

| Glucose (g/mL): Reactor 1 | Glucose (g/mL): Reactor 2 |
|---|---|
| 6.42 | 6.37 |
| 5.95 | 5.97 |
| 5.97 | 5.92 |
| 4.83 | 4.76 |
| 4.61 | 4.44 |
| 2.56 | 2.56 |
| 4.35 | 4.25 |
| 3.95 | 3.9 |
| 2 | 1.89 |
| 3.89 | 3.69 |

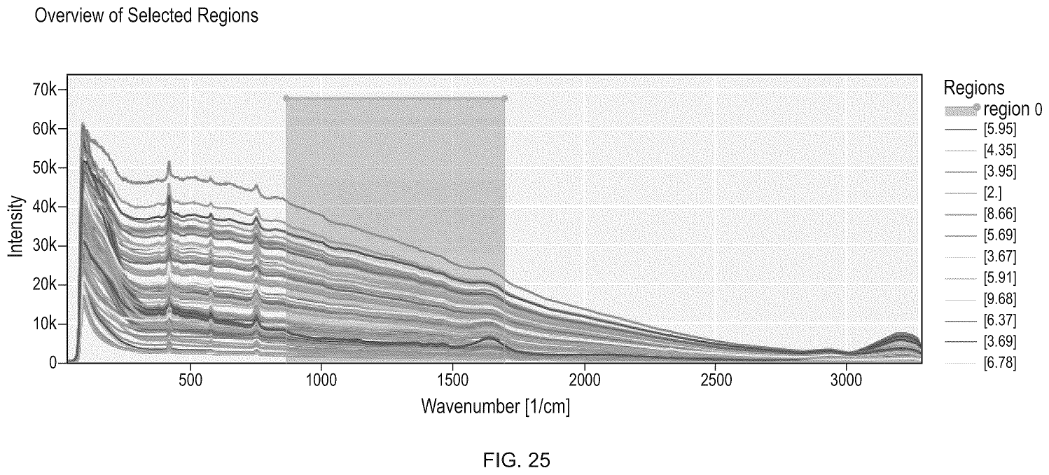

Bayesian Optimization is used to find the best hyperparameters. As used herein the “found hyperparameters” or “optimized hyperparameters” includes the hyperparameter name and hyperparameter value. The best hyperparameters are found by minimizing the leave-one-out cross-validation score from a split of the training data on the models. Table 13 lists best hyperparameters and values according to an implementation. Model n pls refers to number of Latent Variables (LVs) used in PLS Model where 5 is the optimal value. Prep norm as last refers to whether or not normalization should be considered as the last step (true) or the first step (false) of the whole preprocessing sequential steps, and is set to true in this case. Prep norm type refers to the different types of normalization methods available including standard normal variate (SNV), vector normalization or non, and is set to SNV in this case. Prep setting refers to the second preprocessing step such as different baseline correction methods. It can have the values: savgol1: first order Savitzky derivative, savgol2, second order Savitzky derivative, airpls (adavptive iteratively reweighted penalized least squares baseline correction), wavelet (wavelet transformation), multiplicative scatter correction (MSC). In this implementation, the prep setting is set to Savgol1. Prep sg window size refers to the window size of Savitzy-Golya filer if either of these are used and is set to 11 in this case. Prep_airpls_lamda_exp is not listed in this table in this case—that means airpls was not selected as the preprocessing step. If it was selected, the listed value would be the lambda parameters for the airPLS algorithm. Region 0 activated refers to whether or not the first region is used in the algorithm for variable selection and it is set to true in this case meaning it is used. Region 0 end refers to the end of the range of energies (wavenumbers) and is set to 1696.32 cm⁻¹. Region 0 start refers to the beginning of the range of energies and is set to 864.75. The Region threshold refers to the maximum counts (intensity) and is set at 60000. Use region threshold refers to whether or not a saturation threshold is used to exclude any regions. If it is true, any regions with values great than the “region threshold” values will be excluded from data analysis and is set to false. As an example of a hyperparameter, FIG. 25 is a plot representing the hyperparameters related to region 0, where the region 0 end is 1696.32, and the region 0 start is at 864.75. It is understood that according to some embodiments other hyperparameters can be used and optimized.

TABLE 14
Found Hyperparameters Determined by BO.

| Hyperparameter Name | Hyperparameter Value |
|---|---|
| Model n pls | 5 |
| Prep norm as last step | True |
| Prep norm type | snv |
| Prep setting | Savgol1 |
| Prep sg window size | 11 |
| Region 0 activated | True |
| Region 0 end | 1696.32 |
| Region 0 start | 864.75 |
| Region threshold | 60000 |
| Use region threshold | false |

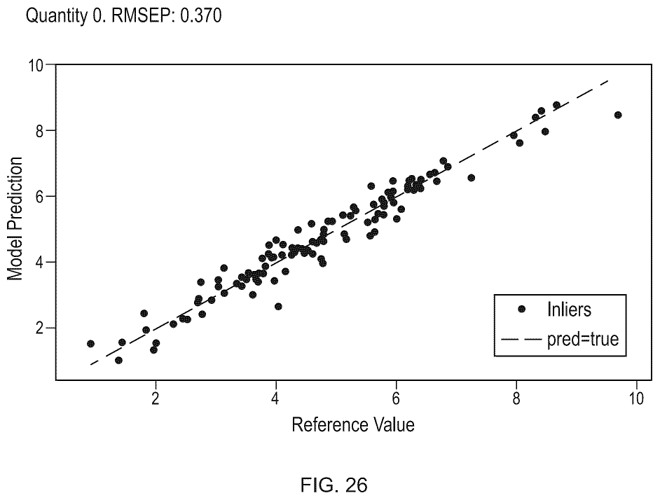

Once the best hyperparameters are identified, the models are trained with all the test data (not including the validation data). The validation data, which includes spectra not used in the training, is then input in the trained models to predict the glucose to validate the model. Table 15 lists the results. Three models were trained, PLS, ElasticNet and LASSO. From the Best value, RMVSEP and RMVSCV values the models are rated as listed from the best model to the worst model. FIG. 26 is a plot of the model prediction to known reference values from the validation data.

TABLE 15
results of model training.

| ID | Model | Best value | Outlier Accuracy | RMSEP | RMSECV |
|---|---|---|---|---|---|
| 46 | PLS | 0.0488964 | 100% | 0.370 | 0.389 |
| 47 | ElasticNet | 0.4176784 | 100% | 1.045 | 1.34 |
| 48 | LASSO | 0.3617881 | 99% | 0.922 | 1.051 |

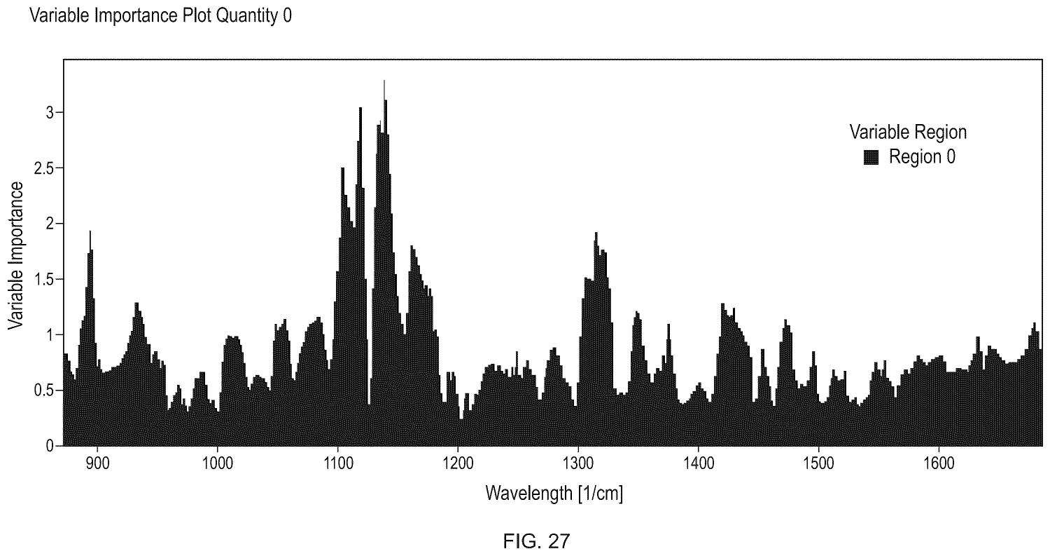

Through the training, the importance of each variable is also determined. In this implementation, the variable is the wavenumber (cm⁻¹). A variable importance to wavelength plot is shown by FIG. 27. In this implementation only one region (region 0 activated) for the wavelength is selected as a hyperparameter, where in the defined range (between the low region 0 end hyperparameter and the high region 0 hyperparameter) the variable importance is high, or at least contain some high values (e.g., above 1). It is noteworthy that glucose Raman spectra has a strong absorbance centered around 1060 cm⁻¹, 1125 cm⁻¹ and 1366 cm⁻¹, and the variable importance is high at and around these values. Other regions with high variable importance may be harder to ascribe to glucose peaks and might be ascribable to peaks from the media and other components in the bioreactor mixture. In other embodiments, different, and sometimes more than one region (e.g. region 1, 2, 3 etc.) might be selected as the found hyperparameters, dependent on the spectral data.

The deployment of the automated chemometrics systems disclosed herein may take any suitable form. In some embodiments, the automated chemometrics systems disclosed herein may be deployed in a cloud environment where the automated optimizations run. Leveraging scalable computing resources in the cloud, many different models may be evaluated (sequentially or in parallel) without blocking the personal computer of the end user. This type of deployment may also reduce or eliminate system requirements on the side of the end user. Once optimized, a model may be transferred to an actual “edge” spectroscopy device, such as an ARM-based iMX6 processor, or an iMX8, in a handheld Raman analyzer, with a Linux operating system, or other handheld or portable spectroscopy device.

In some embodiments, an app for tasks like downloading spectra from the spectroscopy device, uploading these to the cloud, retrieving an optimized model and pushing it to a connected device may be used on a desktop, laptop, or handheld device. Such a “sync app” might even run on the spectroscopy device itself, so data can be directly uploaded to cloud. For example, in some embodiments, a spectroscopy device may expose its own web user interface through which computers on the same network can upload models or download spectra. Spectra can currently also be stored on a network drive within the same network. However, using the cloud as a central place for both data storage and model building might provide an advantageous alternative.

When deploying models to edge spectroscopy devices, the model outcome may desirably be identical on the edge device and in the cloud. In some embodiments, this may be addressed by utilizing an unambiguous model serialization format, as well as identical embodiments of the preprocessing methods and classification/regression models. Further, the model may desirably perform fast. This should include both startup time (e.g., loading model into memory) and inference time (processing a spectrum and returning a classification result).

In some embodiments, the model export feature from Eigenvector Solo may be used to transfer models to a spectroscopy device. Eigenvector Solo supports exporting models as MATLAB scripts, Python (NumPy) scripts, or an XML format, and any suitable format may be used (e.g., XML). Eigenvector exports the model as a sequence of just 11 possible low-level operators (plus, minus, matrix multiplication, etc.). However, this puts a limitation on the extensibility of the collection of models; for example, a Random Forest may be very hard, if not impossible, to express with just these operators. In some embodiments, this XML format may be extended with more high-level operators like Random Forest.

In some embodiments, a C++ implementation of the model collection may be used. This approach allows high-level functions like RandomForest( ) and PCA( ), instead of expressing PCA as a sequence of basic linear algebra operators. The model may still be interpretable both in the cloud (optimization) environment and on the edge spectroscopy device. In some embodiments, if maintaining the optimization and experimentation code in C++ is not desirable, interfaces for a higher-level language like Python may be used, e.g., by maintaining independent implementations in Python and C++ (which may allow the use of, for example, Random Forest from the popular scikit-learn library, for which a similar C++ implementation is needed, and which may serialize model parameters in Python and deserialize them in C++), or by maintaining C++ implementations along with Python bindings (which may guarantee the same outcomes in C++ and Python, and may employ the native serialization format of the library used). Some options per model type are listed in Table 16.

TABLE 16
C++ implementations for various models.

| Model | Possible C++ implementation |
|---|---|
| PCA | Use XML format or mlpack (python bindings) |
| PLS(-DA) | Use XML format or brunexgeek |
| Random Forest | mlpack (python bindings) |
| SVM | mlpack (linear kernel only, python bindings) |

In some embodiments, a MATLAB implementation of the model collection may be used. In some embodiments, a MATLAB modeling codebase may be maintained, and its code generation functionality may be used, to automatically generate C++ implementations of a model. In some embodiments, because Python has some advantageous hyperparameter optimization libraries, and may be a desirable language to use for developing an eventual cloud optimization service, it may be advantageous in some applications to keep large parts of the codebase in Python and only wrap model calls to MATLAB.

In some embodiments, Python may be embedded in a C++ app. In this approach, Python functions are called (by including the Python.h header file) from the software of a handheld spectroscopy device, which itself might still be written in C++. Almost all relevant Python libraries are readily available for ARM architectures. Because the underlying implementations of the Python algorithms are often in C or Fortran, there may be few actual Python function calls. For inference, the speed difference versus a native C++ implementation may be negligible. (Dynamically) loading the Python module into memory, before doing the inference, might cost a bit more time versus a precompiled C++ model, but the difference may not be substantial.

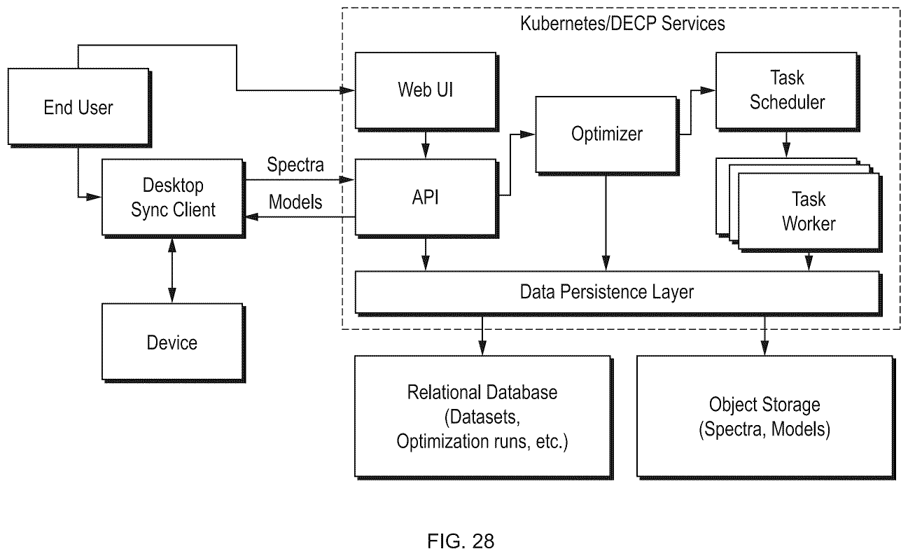

A possible cloud architecture is depicted in FIG. 28. In this architecture, an end user controls the cloud upload of device spectra via a personal sync client (e.g., desktop, laptop, or handheld computing device). In some embodiments, this sync client may be made as small as possible and offload as much functionality as possible to a web user interface, because a web application may be easier to update then a desktop application. The sync client may also be responsible for pushing a selected model to an attached spectroscopy device. The sync client could also run on the spectroscopy device itself. Both the web user interface and the client send commands to an application programming interface (API) service. Commands may include uploading spectra, organizing spectra into data sets, starting a model optimization run, fetching optimization results, downloading a model, etc. Optimization runs may be offloaded to an Optimizer service. This service may be responsible for trying different parameter combinations until an optimal model is found. This can be based on any suitable Bayesian optimization software. For example, this can be based on the optimization library SMAC3, an OPTUNA library, or some other library. The optimizer itself may only do lightweight computations; heavy tasks such as training a model with given hyperparameters may be offloaded to a Task scheduler and associated Task workers. In some embodiments, such a scheduler/worker system could be implemented by an existing technology, such as Dask or Celery. SMAC3 already supports submitting jobs to Dask, and thus may be used in some implementations. The number of workers may be scaled based on the amount of work in the queue, which may be determined by, for example, the number of parallel optimizations and parallel users. In turn, increasing the number of workers may trigger an increase in the amount of Kubernetes nodes (computers) or other microservice management system, leading to an automatically scaling solution.

Continuing to refer to FIG. 28, a Data persistence layer service may hide the underlying data storage implementations. The data storage may live outside of the (e.g., Kubernetes) cluster, in a Relational Database (which can be fully managed by the cloud provider) and Object Storage (e.g., provided by Amazon S3 or a similar service). In some embodiments, the raw binary spectra and serialized models may be stored as files in the Object Storage, while Metadata on the spectra (like the device that recorded it, substance, data sets that group multiple spectra, etc.) may be stored in the Relational Database. In some embodiments, data related to the (historic) optimization runs, resulting models and their performance can be stored in the database.

Various ones of the examples of applications of the AutoML systems disclosed herein have been directed to authentication and identification tasks in chemometrics. In other embodiments, the AutoML systems disclosed herein may be used for quantification tasks (e.g., to estimate the concentration of a substance).

In some embodiments, the AutoML systems disclosed herein may include an extra ensemble layer. Herein, the predictions of several models can be combined, to probably gain an extra increase in performance and robustness. These models can either be several different configurations of one base model, where several good performing models found during the Bayesian Optimization are used, or it can be an ensemble of the best performing model for each of the base models.

In some embodiments, the AutoML systems disclosed herein may use more than one spectrum for a sample (e.g., the original spectrum and its first derivative).

In some embodiments, the AutoML systems disclosed herein may use a database of potential outliers to test against to improve outlier detection and develop specifically optimized outlier detection methods.

In some embodiments, as discussed above, a noise model could be used when samples of individual measurements are available, rather than averaged samples. This could lead to better performance for data sets with a very limited sample size.

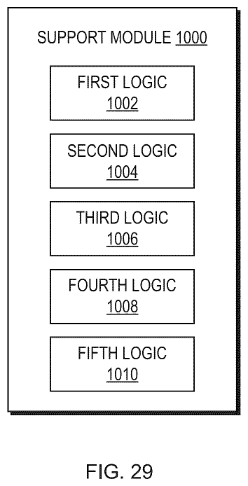

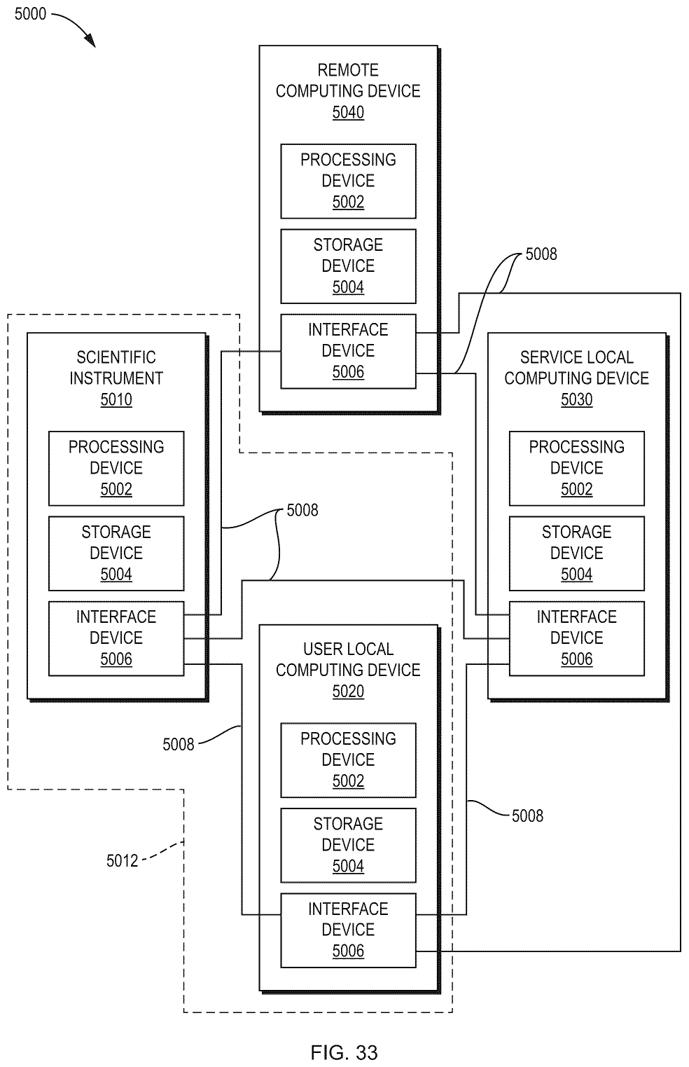

FIG. 29 is a block diagram of a scientific instrument support module 1000 for performing support operations, in accordance with various embodiments. The scientific instrument support module 1000 may be implemented by circuitry (e.g., including electrical and/or optical components), such as a programmed computing device. The logic of the scientific instrument support module 1000 may be included in a single computing device or may be distributed across multiple computing devices that are in communication with each other as appropriate. Examples of computing devices that may, singly or in combination, implement the scientific instrument support module 1000 are discussed herein with reference to the computing device 4000 of FIG. 32, and examples of systems of interconnected computing devices, in which the scientific instrument support module 1000 may be implemented across one or more of the computing devices, is discussed herein with reference to the scientific instrument support system 5000 of FIG. 33.

The scientific instrument support module 1000 may include first logic 1002, second logic 1004, a third logic 1006, a fourth logic 1008, and a fifth logic 1010. As used herein, the term “logic” may include an apparatus that is to perform a set of operations associated with the logic. For example, any of the logic elements included in the support module 1000 may be implemented by one or more computing devices programmed with instructions to cause one or more processing devices of the computing devices to perform the associated set of operations. In a particular embodiment, a logic element may include one or more non-transitory computer-readable media having instructions thereon that, when executed by one or more processing devices of one or more computing devices, cause the one or more computing devices to perform the associated set of operations. As used herein, the term “module” may refer to a collection of one or more logic elements that, together, perform a function associated with the module. Different ones of the logic elements in a module may take the same form or may take different forms. For example, some logic in a module may be implemented by a programmed general-purpose processing device, while other logic in a module may be implemented by an application-specific integrated circuit (ASIC). In another example, different ones of the logic elements in a module may be associated with different sets of instructions executed by one or more processing devices. A module may not include all of the logic elements depicted in the associated drawing; for example, a module may include a subset of the logic elements depicted in the associated drawing when that module is to perform a subset of the operations discussed herein with reference to that module.

The first logic 1002 may manage and pre-process data to be used for training a model in accordance with any of the autochemometric systems disclosed herein. The first logic 1002 may manage the storage and pre-processing of any such data (e.g., any of the types of data discussed as examples herein), and may include any suitable hardware and programmed software for doing so (e.g., any suitable ones of the elements discussed above with reference to FIG. 28).

The second logic 1004 may manage the training of one or more models and provides the one or more trained models for further steps. The second logic 1004 may, for example, manage the selection of hyperparameters for models and the training of models in accordance with any of the embodiments of autochemometric systems disclosed herein. The second logic 1004 may include any suitable hardware and programmed software for doing so (e.g., any suitable ones of the elements discussed above with reference to FIG. 28).

The third logic 1006 may manage a measure of the quality of the model and provide one or more found hyperparameters of the model). For example, the third logic 1006 may provide the measure of the quality of the model and or one of the found hyperparameters as an output of the display device 4010 described herein with reference to FIG. 32. For example the quality of the model and the found hyperparameters, such as presented in Table 14 and Table 15, can be displayed by display device 4010. In some embodiments, the third logic 1006 stores the quality of the model and found hyperparameters as data in the storage device 4004 The third logic 1006 may include any suitable hardware and programmed software for doing so (e.g., any suitable ones of the elements discussed above with reference to FIG. 28).

The fourth logic 1008 may accept the found hyperparameters, such as from the third logic 1006, and train the one or more models. For example, the fourth logic 1008 can be implemented on a different computing device than the second logic. The third logic 1006 may include any suitable hardware and programmed software for doing so (e.g., any suitable ones of the elements discussed above with reference to FIG. 28).

The fifth logic 1010 may manage the application of the one of more models to a test sample data to identify, a qualitative or quantitative feature of one or more substances in the test sample. In some embodiments the first logic, the second logic, and the third logic can be implemented on a first computing device, and the fifth logic is implemented on a second computing device.

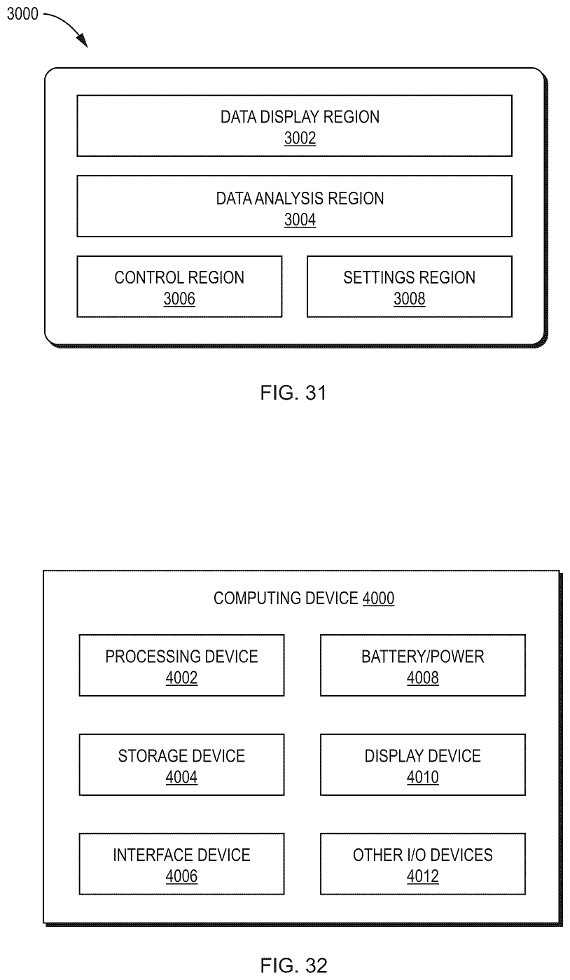

FIG. 30A is a flow diagram of a method 2000 of performing support operations, in accordance with various embodiments. Although the operations of the method 2000 may be illustrated with reference to particular embodiments disclosed herein (e.g., the scientific instrument support modules 1000 discussed herein with reference to FIG. 29, the GUI 3000 discussed herein with reference to FIG. 31, the computing devices 4000 discussed herein with reference to FIG. 29, and/or the scientific instrument support system 5000 discussed herein with reference to FIG. 33), the method 2000 may be used in any suitable setting to perform any suitable support operations. Operations are illustrated once each and in a particular order in FIG. 30A, but the operations may be reordered and/or repeated as desired and appropriate (e.g., different operations performed may be performed in parallel, as suitable). Some operations may be optional, such as fourth operations 2008 and fifth operations 2010.

At 2002, first operations may be performed. For example, the first logic 1002 of a support module 1000 may perform the operations of 2002. FIG. 30B is a flow diagram of sub-operations performed as part of the first operations 2002. A first sub-operation 20021 may include receiving or importing a dataset such as spectrum data from a spectrometer device (e.g., a handheld, portable or benchtop spectrometer, such as a Raman spectrometer) representative of a sample under test. A second sub-operation 20022 may include a pre-processing step as described herein. In some embodiments, the pre-processing step is normalization of the spectral data. For example, normalization of the energy (wavelength or wavenumber) so that all data pixels from the different spectra in the dataset are normalized. This can be done, for example by normalizing to a known reference such as an internal standard (water peak, sapphire peak from a lens) or an externally measured standard. As another example, the counts or intensity can be normalized. This can also be done by an internal or external standard. In some embodiments, no normalization is required. A third sub-operation 20023 may include selecting a problem type. For example, the problem type can be one of classification or quantification. In some embodiments, additional sub-problem types can be selected, such as authentication where the presence or absence of a specific compound is the problem type, which is a sub-class of the classification problem type The first operations 2002 and sub-operations may be performed in accordance with any of the embodiments disclosed herein.

At 2004, second operations may be performed. For example, the second logic 1004 of a support module 1000 may perform the operations of 2004. FIG. 30C is a flow diagram of sub-operations performed as part of the second operations 2004. A fourth sub-operation 20044 may be to split the data into a training set and a test set. For example, the split can be a random split or a manual split. A fifth sub-operation is to select the model type to train (e.g., LASSO, PLS, Random Forest) and depends at least in part on the problem type. The fifth sub-operation can be done before or after the fourth sub-operation. A sixth sub-operation 20046 may be to optimize the hyperparameters for the selected models. This can be done by Bayesian Optimization which includes splitting the training data into a training split and a validation split. A seventh sub-operations 20047 may be to use all of the training data and the found hyperparameters, which were found during the optimization sub-operation 20046 to train the selected models. An eighth sub-operation 20048 may be to validate the model using the test data split from the training data in fourth sub-operation 20044. Validation determines a quality measure of the trained model. The second operations 2004 and sub-operations may be performed in accordance with any of the embodiments disclosed herein.

At 2006, third operations may be performed. For example, the third logic 1006 of a support module 1000 may perform the operations of 2006. The third operations may include providing a measure of the quality of the trained model and the found hyperparameters. The third operation may include outputting data representative of quality of the trained model, such as depicted by Table 15, FIG. 26 or FIG. 27. In some embodiments, the data is output to a user. In some embodiments, the found hyperparameters are provided to the fourth logic 1008 for execution of fourth operations 2008 as described below. In some embodiments, the trained model and found hyperparameters are provided to the fifth logic 1010 for execution of fifth operations 2010 as described below. In some embodiments, the third operations 2006 may be performed in accordance with any of the embodiments disclosed herein.

At 2008, fourth operations may be performed. For example, the fourth logic 1008 of support module 1000 may perform the operations of 2008. FIG. 30D is a flow diagram of sub-operations performed as part of the fourth operations 2008. An eighth sub-operations 20088 may include accepting or receiving the found hyperparameters optimized in sixth sub-operation 20046. A ninth sub-operation 20089 may include training models using the found hyperparameters. The models may be trained on the same dataset imported in step 20021, a subset of this dataset, a combination of this dataset and a different dataset, or a different dataset. In some embodiments, the different dataset is in the same statistical population as the dataset imported in step 20021. For example, in a qualitative problem to determine concentrations, the datasets are in the same population if the concentration ranges encompassing the individual data are the same and the species (e.g., glucose, BSA) are the same. As another example, in a qualitative problem such as determining the providence of a species, such as a serum, the species are the same, such as all being a bovine serum. In some embodiments, the training sub-operation 20089 may use substantially the same operations as described with reference to FIG. 30C for the second operations 2004. In some embodiments, the second operations 2004 can be performed on a first computing device 4000 discussed herein with reference to FIG. 32, and the training sub-operation 20089 are performed on a second computing device 4000.

At 2010, fifth operations may be performed. The fifth operations may include the sub-operations depicted by FIG. 30 E. These sub-operations generated substance information for a spectrum of a sample. A tenth sub-operation 201010 may include measuring or providing the sample spectrum. An eleventh sub-operation 201011 may include applying or inputting data representative of the spectrum data to the trained models found by sixth sub-operations 20046 to generate the substance identification information (e.g., information that can be used to identify the sample under test from a set of possible substances and/or authenticate that the sample under test is a particular substance—or to quantify the sample under test). A twelfth sub-operation 201012 may also include outputting data representative of the substance identification information (e.g., by causing the identity of the sample under test to be displayed in a graphical user interface, by causing the identity of the sample under test to be entered into a local or remote database, etc.); such fifth operations 2010 may be performed in accordance with any of the embodiments disclosed herein. The scientific instrument support methods disclosed herein may include interactions with a human user (e.g., via a display on a scientific instrument, such as a handheld spectroscopy device, or via the user local computing device 5020 discussed herein with reference to FIG. 33). These interactions may include providing information to the user (e.g., information regarding the operation of a scientific instrument such as the scientific instrument 5010 of FIG. 33, information regarding a sample being analyzed or other test or measurement performed by a scientific instrument, information retrieved from a local or remote database, or other information) or providing an option for a user to input commands (e.g., to control the operation of a scientific instrument such as the scientific instrument 5010 of FIG. 33, or to control the analysis of data generated by a scientific instrument), queries (e.g., to a local or remote database), or other information. In some embodiments, these interactions may be performed through a graphical user interface (GUI) that includes a visual display on a display device (e.g., the display device 4010 discussed herein with reference to FIG. 32) that provides outputs to the user and/or prompts the user to provide inputs (e.g., via one or more input devices, such as a keyboard, mouse, trackpad, or touchscreen, included in the other I/O devices 4012 discussed herein with reference to FIG. 32). The scientific instrument support systems disclosed herein may include any suitable GUIs for interaction with a user.

FIG. 31 depicts an example GUI 3000 that may be used in the performance of some or all of the support methods disclosed herein, in accordance with various embodiments. As noted above, the GUI 3000 may be provided on a display device (e.g., the display device 4010 discussed herein with reference to FIG. 32) of a computing device (e.g., the computing device 4000 discussed herein with reference to FIG. 32) of a scientific instrument support system (e.g., the scientific instrument support system 5000 discussed herein with reference to FIG. 33), and a user may interact with the GUI 3000 using any suitable input device (e.g., any of the input devices included in the other I/O devices 4012 discussed herein with reference to FIG. 32) and input technique (e.g., movement of a cursor, motion capture, facial recognition, gesture detection, voice recognition, actuation of buttons, etc.).

The GUI 3000 may include a data display region 3002, a data analysis region 3004, a scientific instrument control region 3006, and a settings region 3008. The particular number and arrangement of regions depicted in FIG. 31 is simply illustrative, and any number and arrangement of regions, including any desired features, may be included in a GUI 3000.

The data display region 3002 may display data generated by a scientific instrument (e.g., the scientific instrument 5010 discussed herein with reference to FIG. 33). For example, the data display region 3002 may display spectrum data generated by a spectroscopy device (e.g., a handheld spectroscopy device, such as a handheld Raman spectrometer).

The data analysis region 3004 may display the results of data analysis (e.g., the results of analyzing the data illustrated in the data display region 3002 and/or other data). For example, the data analysis region 3004 may display the substances identified in a sample under test, or an authentication message indicating that a sample under test is or is not a particular substance, in accordance with any of the autochemometric approaches disclosed herein. As another example, the data analysis region 3004 may display the found hyperparameters such as shown by Table 14 or the measure of quality of the trained models as shown by Table 15. In some embodiments, the data display region 3002 and the data analysis region 3004 may be combined in the GUI 3000 (e.g., to include data output from a scientific instrument, and some analysis of the data, in a common graph or region).

The scientific instrument control region 3006 may include options that allow the user to control a scientific instrument (e.g., the scientific instrument 5010 discussed herein with reference to FIG. 33). For example, the scientific instrument control region 3006 may include several function buttons, such as a power button, login/logoff, barcode scanner, scan time or timeout, minimum signal to noise for a scan, cancel command, scrolling control for built in options etc.

The settings region 3008 may include options that allow the user to control the features and functions of the GUI 3000 (and/or other GUIs) and/or perform common computing operations with respect to the data display region 3002 and data analysis region 3004 (e.g., saving data on a storage device, such as the storage device 4004 discussed herein with reference to FIG. 32, sending data to another user, labeling data, etc.). For example, the settings region 3008 may include an option to send an e-mail with the results of the autochemometric analysis to another party.

As noted above, the scientific instrument support module 1000 may be implemented by one or more computing devices. FIG. 32 is a block diagram of a computing device 4000 that may perform some or all of the scientific instrument support methods disclosed herein, in accordance with various embodiments. In some embodiments, the scientific instrument support module 1000 may be implemented by a single computing device 4000 or by multiple computing devices 4000. Further, as discussed below, a computing device 4000 (or multiple computing devices 4000) that implements the scientific instrument support module 1000 may be part of one or more of the scientific instrument 5010, the user local computing device 5020, the service local computing device 5030, or the remote computing device 5040 of FIG. 33.

The computing device 4000 of FIG. 32 is illustrated as having a number of components, but any one or more of these components may be omitted or duplicated, as suitable for the application and setting. In some embodiments, some or all of the components included in the computing device 4000 may be attached to one or more motherboards and enclosed in a housing (e.g., including plastic, metal, and/or other materials). In some embodiments, some these components may be fabricated onto a single system-on-a-chip (SoC) (e.g., an SoC may include one or more processing devices 4002 and one or more storage devices 4004). Additionally, in various embodiments, the computing device 4000 may not include one or more of the components illustrated in FIG. 32, but may include interface circuitry (not shown) for coupling to the one or more components using any suitable interface (e.g., a Universal Serial Bus (USB) interface, a High-Definition Multimedia Interface (HDMI) interface, a Controller Area Network (CAN) interface, a Serial Peripheral Interface (SPI) interface, an Ethernet interface, a wireless interface, or any other appropriate interface). For example, the computing device 4000 may not include a display device 4010, but may include display device interface circuitry (e.g., a connector and driver circuitry) to which a display device 4010 may be coupled.

The computing device 4000 may include a processing device 4002 (e.g., one or more processing devices). As used herein, the term “processing device” may refer to any device or portion of a device that processes electronic data from registers and/or memory to transform that electronic data into other electronic data that may be stored in registers and/or memory. The processing device 4002 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices.

The computing device 4000 may include a storage device 4004 (e.g., one or more storage devices). The storage device 4004 may include one or more memory devices such as random access memory (RAM) (e.g., static RAM (SRAM) devices, magnetic RAM (MRAM) devices, dynamic RAM (DRAM) devices, resistive RAM (RRAM) devices, or conductive-bridging RAM (CBRAM) devices), hard drive-based memory devices, solid-state memory devices, networked drives, cloud drives, or any combination of memory devices. In some embodiments, the storage device 4004 may include memory that shares a die with a processing device 4002. In such an embodiment, the memory may be used as cache memory and may include embedded dynamic random access memory (eDRAM) or spin transfer torque magnetic random access memory (STT-MRAM), for example. In some embodiments, the storage device 4004 may include non-transitory computer readable media having instructions thereon that, when executed by one or more processing devices (e.g., the processing device 4002), cause the computing device 4000 to perform any appropriate ones of or portions of the methods disclosed herein.

The computing device 4000 may include an interface device 4006 (e.g., one or more interface devices 4006). The interface device 4006 may include one or more communication chips, connectors, and/or other hardware and software to govern communications between the computing device 4000 and other computing devices. For example, the interface device 4006 may include circuitry for managing wireless communications for the transfer of data to and from the computing device 4000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. Circuitry included in the interface device 4006 for managing wireless communications may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). In some embodiments, circuitry included in the interface device 4006 for managing wireless communications may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. In some embodiments, circuitry included in the interface device 4006 for managing wireless communications may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). In some embodiments, circuitry included in the interface device 4006 for managing wireless communications may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. In some embodiments, the interface device 4006 may include one or more antennas (e.g., one or more antenna arrays) to receipt and/or transmission of wireless communications.

In some embodiments, the interface device 4006 may include circuitry for managing wired communications, such as electrical, optical, or any other suitable communication protocols. For example, the interface device 4006 may include circuitry to support communications in accordance with Ethernet technologies. In some embodiments, the interface device 4006 may support both wireless and wired communication, and/or may support multiple wired communication protocols and/or multiple wireless communication protocols. For example, a first set of circuitry of the interface device 4006 may be dedicated to shorter-range wireless communications such as Wi-Fi or Bluetooth, and a second set of circuitry of the interface device 4006 may be dedicated to longer-range wireless communications such as global positioning system (GPS), EDGE, GPRS, CDMA, WiMAX, LTE, EV-DO, or others. In some embodiments, a first set of circuitry of the interface device 4006 may be dedicated to wireless communications, and a second set of circuitry of the interface device 4006 may be dedicated to wired communications.

The computing device 4000 may include battery/power circuitry 4008. The battery/power circuitry 4008 may include one or more energy storage devices (e.g., batteries or capacitors) and/or circuitry for coupling components of the computing device 4000 to an energy source separate from the computing device 4000 (e.g., AC line power).

The computing device 4000 may include a display device 4010 (e.g., multiple display devices). The display device 4010 may include any visual indicators, such as a heads-up display, a computer monitor, a projector, a touchscreen display, a liquid crystal display (LCD), a light-emitting diode display, or a flat panel display.

The computing device 4000 may include other input/output (I/O) devices 4012. The other I/O devices 4012 may include one or more audio output devices (e.g., speakers, headsets, earbuds, alarms, etc.), one or more audio input devices (e.g., microphones or microphone arrays), location devices (e.g., GPS devices in communication with a satellite-based system to receive a location of the computing device 4000, as known in the art), audio codecs, video codecs, printers, sensors (e.g., thermocouples or other temperature sensors, humidity sensors, pressure sensors, vibration sensors, accelerometers, gyroscopes, etc.), image capture devices such as cameras, keyboards, cursor control devices such as a mouse, a stylus, a trackball, or a touchpad, bar code readers, Quick Response (QR) code readers, or radio frequency identification (RFID) readers, for example.

The computing device 4000 may have any suitable form factor for its application and setting, such as a handheld or mobile computing device (e.g., a cell phone, a smart phone, a mobile internet device, a tablet computer, a laptop computer, a netbook computer, an ultrabook computer, a personal digital assistant (PDA), an ultra mobile personal computer, etc.), a desktop computing device, or a server computing device or other networked computing component.

One or more computing devices implementing any of the scientific instrument support modules or methods disclosed herein may be part of a scientific instrument support system. FIG. 33 is a block diagram of an example scientific instrument support system 5000 in which some or all of the scientific instrument support methods disclosed herein may be performed, in accordance with various embodiments. The scientific instrument support modules and methods disclosed herein (e.g., the scientific instrument support module 1000 of FIG. 29 and the method 2000 of FIG. 30A) may be implemented by one or more of the scientific instruments 5010, the user local computing device 5020, the service local computing device 5030, or the remote computing device 5040 of the scientific instrument support system 5000. In some embodiments, the scientific instrument support system 5000 may implement the system of FIG. 28, with elements of the system of FIG. 28 implemented by any suitable elements of the scientific instrument support system 5000 of FIG. 33.

Any of the scientific instrument 5010, the user local computing device 5020, the service local computing device 5030, or the remote computing device 5040 may include any of the embodiments of the computing device 4000 discussed herein with reference to FIG. 32, and any of the scientific instrument 5010, the user local computing device 5020, the service local computing device 5030, or the remote computing device 5040 may take the form of any appropriate ones of the embodiments of the computing device 4000 discussed herein with reference to FIG. 32.

The scientific instrument 5010, the user local computing device 5020, the service local computing device 5030, or the remote computing device 5040 may each include a processing device 5002, a storage device 5004, and an interface device 5006. The processing device 5002 may take any suitable form, including the form of any of the processing devices 4002 discussed herein with reference to FIG. 32, and the processing devices 5002 included in different ones of the scientific instrument 5010, the user local computing device 5020, the service local computing device 5030, or the remote computing device 5040 may take the same form or different forms. The storage device 5004 may take any suitable form, including the form of any of the storage devices 4004 discussed herein with reference to FIG. 32, and the storage devices 5004 included in different ones of the scientific instrument 5010, the user local computing device 5020, the service local computing device 5030, or the remote computing device 5040 may take the same form or different forms. The interface device 5006 may take any suitable form, including the form of any of the interface devices 4006 discussed herein with reference to FIG. 32, and the interface devices 5006 included in different ones of the scientific instrument 5010, the user local computing device 5020, the service local computing device 5030, or the remote computing device 5040 may take the same form or different forms.

The scientific instrument 5010, the user local computing device 5020, the service local computing device 5030, and the remote computing device 5040 may be in communication with other elements of the scientific instrument support system 5000 via communication pathways 5008. The communication pathways 5008 may communicatively couple the interface devices 5006 of different ones of the elements of the scientific instrument support system 5000, as shown, and may be wired or wireless communication pathways (e.g., in accordance with any of the communication techniques discussed herein with reference to the interface devices 4006 of the computing device 4000 of FIG. 32). The particular scientific instrument support system 5000 depicted in FIG. 33 includes communication pathways between each pair of the scientific instrument 5010, the user local computing device 5020, the service local computing device 5030, and the remote computing device 5040, but this “fully connected” implementation is simply illustrative, and in various embodiments, various ones of the communication pathways 5008 may be absent. For example, in some embodiments, a service local computing device 5030 may not have a direct communication pathway 5008 between its interface device 5006 and the interface device 5006 of the scientific instrument 5010, but may instead communicate with the scientific instrument 5010 via the communication pathway 5008 between the service local computing device 5030 and the user local computing device 5020 and the communication pathway 5008 between the user local computing device 5020 and the scientific instrument 5010.

The scientific instrument 5010 may include any appropriate scientific instrument, such as a spectroscopy device. As noted above, in some embodiments, the scientific instrument 5010 may be a portable or handheld spectroscopy device, such as a handheld Raman spectrometer.

The user local computing device 5020 may be a computing device (e.g., in accordance with any of the embodiments of the computing device 4000 discussed herein) that is local to a user of the scientific instrument 5010. In some embodiments, the user local computing device 5020 may also be local to the scientific instrument 5010, but this need not be the case; for example, a user local computing device 5020 that is in a user's home or office may be remote from, but in communication with, the scientific instrument 5010 so that the user may use the user local computing device 5020 to control and/or access data from the scientific instrument 5010. In some embodiments, the user local computing device 5020 may be a laptop, smartphone, or tablet device. In some embodiments the user local computing device 5020 may be a portable computing device.

The service local computing device 5030 may be a computing device (e.g., in accordance with any of the embodiments of the computing device 4000 discussed herein) that is local to an entity that services the scientific instrument 5010. For example, the service local computing device 5030 may be local to a manufacturer of the scientific instrument 5010 or to a third-party service company. In some embodiments, the service local computing device 5030 may communicate with the scientific instrument 5010, the user local computing device 5020, and/or the remote computing device 5040 (e.g., via a direct communication pathway 5008 or via multiple “indirect” communication pathways 5008, as discussed above) to receive data regarding the operation of the scientific instrument 5010, the user local computing device 5020, and/or the remote computing device 5040 (e.g., the results of self-tests of the scientific instrument 5010, calibration coefficients used by the scientific instrument 5010, the measurements of sensors associated with the scientific instrument 5010, etc.). In some embodiments, the service local computing device 5030 may communicate with the scientific instrument 5010, the user local computing device 5020, and/or the remote computing device 5040 (e.g., via a direct communication pathway 5008 or via multiple “indirect” communication pathways 5008, as discussed above) to transmit data to the scientific instrument 5010, the user local computing device 5020, and/or the remote computing device 5040 (e.g., to update programmed instructions, such as firmware, in the scientific instrument 5010, to initiate the performance of test or calibration sequences in the scientific instrument 5010, to update programmed instructions, such as software, in the user local computing device 5020 or the remote computing device 5040, etc.). A user of the scientific instrument 5010 may utilize the scientific instrument 5010 or the user local computing device 5020 to communicate with the service local computing device 5030 to report a problem with the scientific instrument 5010 or the user local computing device 5020, to request a visit from a technician to improve the operation of the scientific instrument 5010, to order consumables or replacement parts associated with the scientific instrument 5010, or for other purposes.

The remote computing device 5040 may be a computing device (e.g., in accordance with any of the embodiments of the computing device 4000 discussed herein) that is remote from the scientific instrument 5010 and/or from the user local computing device 5020. In some embodiments, the remote computing device 5040 may be included in a datacenter or other large-scale server environment. In some embodiments, the remote computing device 5040 may include network-attached storage (e.g., as part of the storage device 5004). The remote computing device 5040 may store data generated by the scientific instrument 5010, perform analyses of the data generated by the scientific instrument 5010 (e.g., in accordance with programmed instructions), facilitate communication between the user local computing device 5020 and the scientific instrument 5010, and/or facilitate communication between the service local computing device 5030 and the scientific instrument 5010.

In some embodiments, one or more of the elements of the scientific instrument support system 5000 illustrated in FIG. 33 may not be present. Further, in some embodiments, multiple ones of various ones of the elements of the scientific instrument support system 5000 of FIG. 33 may be present. For example, a scientific instrument support system 5000 may include multiple user local computing devices 5020 (e.g., different user local computing devices 5020 associated with different users or in different locations). In another example, a scientific instrument support system 5000 may include multiple scientific instruments 5010, all in communication with service local computing device 5030 and/or a remote computing device 5040; in such an embodiment, the service local computing device 5030 may monitor these multiple scientific instruments 5010, and the service local computing device 5030 may cause updates or other information may be “broadcast” to multiple scientific instruments 5010 at the same time. Different ones of the scientific instruments 5010 in a scientific instrument support system 5000 may be located close to one another (e.g., in the same room) or farther from one another (e.g., on different floors of a building, in different buildings, in different cities, etc.). In some embodiments, a scientific instrument 5010 may be connected to an Internet-of-Things (IoT) stack that allows for command and control of the scientific instrument 5010 through a web-based application, a virtual or augmented reality application, a mobile application, and/or a desktop application. Any of these applications may be accessed by a user operating the user local computing device 5020 in communication with the scientific instrument 5010 by the intervening remote computing device 5040. In some embodiments, a scientific instrument 5010 may be sold by the manufacturer along with one or more associated user local computing devices 5020 as part of a local scientific instrument computing unit 5012.

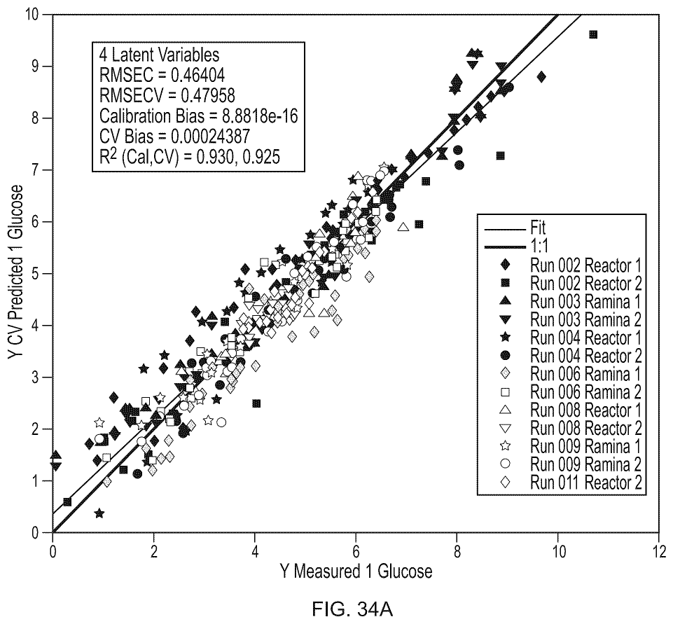

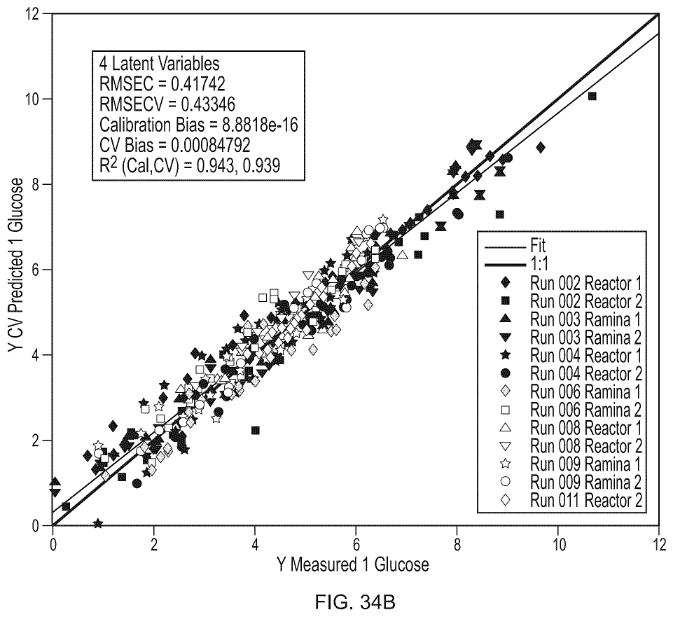

The found hyperparameters shown in Table 14 were applied to a commercial training software (Solo_Predictor, from Eigenvector Research, Inc) to train a PLS model. The hyperparameters were found by the expert user investing less than an hour of time for tasks such as selected the datasets and selecting the problem type. After these simple tasks, Bayesian Optimization proceeded without user interaction to provide the found hyperparameters. For comparison, an expert user selected hyperparameters and applied these for PLS model training. In this manual selection of hyperparameters, the expert user spent more than a workday to select the hyperparameters, where different selections of hyperparameters were used in several iterations to train the PLS model. Results of these approaches are depicted in FIGS. 34A and 34B. FIG. 34A depicts the quality of the PLS model where the expert user determined the best hyperparameters and gave an RMSEC value of 0.46404. FIG. 34B depicts the quality of the PLS model where the found hyperparameters listed in Table 14 were used and gave an RMSEC value of 0.41742. This shows some benefits of the methods described herein for finding hyperparameters to train chemometric models: the methods are efficient and can provide higher quality trained models.

The following numbered paragraphs 1-32 provide various examples of the embodiments disclosed herein.

Paragraph 1. A scientific instrument support apparatus, comprising:
a first logic to manage and pre-process a spectroscopic data set;
a second logic to train one or more models and provide one ore more of a trained model; and
a third logic to provide a measure of a quality of the one or more trained models and provide a one or more of a found hyperparameter of the trained model.

Paragraph 2. The scientific instrument support apparatus according to paragraph 1, wherein the spectroscopic data set includes Raman data from measurements of different training samples.

Paragraph 3. The scientific instrument support apparatus according to paragraph 1 or paragraph 2, wherein the different training samples include one or more of, a media variation, a processing parameter variation, a target material variation, a reactor variation, and a spectroscopic instrument variation.

Paragraph 4. The scientific instrument support apparatus according to paragraph 3, wherein the media variation is one or more of an initial media composition and a subsequent second media composition.

Paragraph 5. The scientific instrument support apparatus according to paragraph 3 or paragraph 4, wherein the processing parameter variation is one or more of a feed rate of the media, a feed type of the media (e.g., bolus or continuous), a target material feed rate, and a run mode (e.g., fed batch or continuous). In a first option, the processing parameter variation is the feed rate of media. In a second option, the processing parameter variation is the feed type of the media. In a third option, the processing parameter variation is the target material feed rate. In a fourth option, the processing parameter variation is the run mode.

Paragraph 6. The scientific instrument support apparatus according to any of paragraphs 3-5, wherein the target material variation is one or more of a quantitative variation (e.g., concentration, pH, total cell density, viable cell density) and a qualitative variation (e.g., source or providence, type such as BSA albumin, amine, sugar, acid, aldehyde, amino acid etc.). In a first option the target material variation is a quantitative variation. In a second option, the target material variation is a quantitative variation.

Paragraph 7. The scientific instrument support apparatus according to any of paragraphs 3-6, wherein the reactor variation is one or more of, a reactor type (e.g. bioreactor, high pressure reactor, microreactor, test tube, tube-flow reactor, beaker, flow cell, processing reactor—e.g., for purification), reactor size, and number of reactors. In a first option, the reactor variation is the reactor type. In a second option, the reactor variation is the reactor size. In a third option, the reactor variation is the number of reactors.

Paragraph 8. The scientific instrument support apparatus according to any of paragraph 3-7, wherein the spectroscopic instrument variation is one or more of a spectrometer model, a quantity of spectrometers used, a sample probe model, and a quantity of sample probes. In a first option, the spectrometer variation is the spectrometer model. In a second option, the spectrometer variation is the quantity of spectrometers used. In a third option, the spectrometer variation is the quantity of sample probes used. For example, a sample probe can be a probe with optics to irradiate a sample with excitation light provided from a laser, and with optics to receive sample light such as Raman light from the sample and send it to a spectrometer. Different probes, such as from different commercial sources, can have different responses such as light intensity transmissions or different optic characteristics.

Paragraph 9. The scientific instrument support apparatus according to any of paragraphs 1-8, wherein the first logic accepts a problem type selected from a qualitative challenge or a quantitative challenge.

Paragraph 10. The scientific instrument support apparatus according to paragraph 9, wherein the qualitative challenge is to determine a type or class in a test sample (e.g., a sugar type-glucose, fructose etc., an amine type, a protein type-BSA, etc., providence—BSA from China or Brazil).

Paragraph 11. The scientific instrument support apparatus according to paragraph 9, wherein the quantitative challenge is to determine a concentration of a species in a test sample.

Paragraph 12. The scientific instrument support apparatus according to any of paragraphs 1-11, wherein the first logic preprocesses the spectroscopic data by applying a wavelength normalization.

Paragraph 13. The scientific instrument support apparatus according to any of paragraphs 1-12, wherein the model is input as a selection of different model types by a user to the second logic.

Paragraph 14. The scientific instrument support apparatus according to any of paragraphs 1-13, wherein the model is input as a selection from different model types by the second logic.

Paragraph 15. The scientific instrument support apparatus according to any of paragraphs 1-14, wherein the second logic trains the one or more models by Bayesian Optimization to determine the hyperparameters.

Paragraph 16. The scientific instrument support apparatus according to paragraph 15, wherein a training data is split for the Bayesian Optimization and not-split for model training after determining the hyperparameters. That is, all the training data is used for the model training.

Paragraph 17. The scientific instrument support apparatus according to any of paragraphs 1-16, wherein the third logic provides the found hyperparameters as an output to a user.

Paragraph 18. The scientific instrument support apparatus according to any of paragraphs 1-17, wherein the first logic, the second logic, and the third logic are implemented by a computing device.

Paragraph 19. The scientific instrument support apparatus according to paragraph 18, the computing device is implemented in a scientific instrument, wherein the scientific instrument can measure sample spectroscopic data.

Paragraph 20. The scientific instrument support apparatus according to paragraph 18, wherein the computing device is remote from a scientific instrument, wherein the scientific instrument can measure sample spectroscopic data.

Paragraph 21. The scientific instrument support apparatus according to any of paragraphs 1-14 further comprising a fourth logic, wherein the fourth logic accepts the found hyperparameters and trains the one or more models. Optionally, the model training can be with the same or a different data set but the data sets may be part of the same population.

Paragraph 22. The scientific instrument support apparatus according to paragraph 21 wherein the first logic, the second logic, and the third logic are implemented on a first computing device, and the fourth logic is implemented on a second computing device.

Paragraph 23. The scientific instrument support apparatus according to any of paragraphs 1-22 further comprising a fifth logic to manage an application of the one of more trained models to a test sample data to identify, a qualitative or quantitative feature of one or more substances in the test sample. (i.e., this is also known as model inference where a target property of a sample is inferred from the spectra using the trained model)

Paragraph 24. The scientific instrument support apparatus according to paragraph 23, wherein the first logic, the second logic, and the third logic are implemented on a first computing device, and the fifth logic is implemented on a second computing device.

Paragraph 25. The scientific instrument support apparatus according to paragraph 24, wherein the second computing device is implemented on a scientific instrument, wherein the scientific instrument can measure sample spectroscopic data.

Paragraph 26. A Raman spectrometer comprising:
a support apparatus including;
first logic to manage and pre-process spectroscopic data sets,
second logic to train one or more models and provide one or more trained models,
a third logic to provide a measure of a quality of the one or more trained models and provide a one or more found hyperparameter of the one or more trained models, and
a fifth logic to manage an application of the one of more of the trained models to a test sample data to identify, a qualitative or quantitative feature of one or more substances in the test sample.

Paragraph 27. A method to identify, authenticate or quantify one or more substances in a sample under test, the method comprising:
irradiating the sample with an excitation beam from a spectroscopy device;
collecting data responsive to the excitation beam using the spectroscopy device (e.g., a Raman spectrometer); and
processing the data using a scientific instrument support apparatus according to any one of paragraphs 1-25.

Paragraph 28. A method for scientific instrument support, comprising:
managing and pre-processing data;
training one or more models to provide a trained models;
providing a measure of the quality of the trained model; and
providing a one or more hyperparameter of the trained model.

Paragraph 29. One or more non-transitory computer readable media having instructions thereon that, when executed by one or more processing devices of a scientific instrument support apparatus, cause the scientific instrument support apparatus to perform the method of paragraph 28.

Paragraph 30. The one or more non-transitory computer readable media having instructions thereon according to paragraph 29, wherein the instructions include the first logic, the second logic, and the third logic according to any of paragraphs 1-25.

Paragraph 31. The one or more non-transitory computer readable media having instructions thereon according to paragraph 30 wherein the instructions include the fourth logic according to paragraph 21 or paragraph 22.

Paragraph 32. The one or more non-transitory computer readable media having instructions thereon according to paragraph 30 or paragraph 31 wherein the instructions include the fifth logic according to any od paragraphs 23-25.

1. A scientific instrument support apparatus, comprising:
a first logic to manage and pre-process a spectroscopic data set;
a second logic to train one or more models and provide one or more of a trained model; and
a third logic to provide a measure of a quality of the one or more trained models and provide a one or more of a found hyperparameter of the one or more trained models.

2. The scientific instrument support apparatus according to claim 1, wherein the spectroscopic data set includes Raman data from measurements of different training samples.

3. The scientific instrument support apparatus according to claim 2, wherein the different training samples include one or more of, a media variation, a processing parameter variation, a target material variation, a reactor variation, and a spectroscopic instrument variation.

4.-8. (canceled)

9. The scientific instrument support apparatus according to claim 1, wherein the first logic accepts a problem type selected from a qualitative challenge or a quantitative challenge.

10.-11. (canceled)

12. The scientific instrument support apparatus according to claim 1, wherein the first logic preprocesses the spectroscopic data by applying a wavelength normalization.

13. The scientific instrument support apparatus according to claim 1, wherein the model is input as a selection of different model types by a user to the second logic.

14. The scientific instrument support apparatus according to claim 1, wherein the model is input as a selection from different model types by the second logic.

15. The scientific instrument support apparatus according to claim 1, wherein the second logic trains the one or more models by Bayesian Optimization to determine the hyperparameters.

16. (canceled)

17. The scientific instrument support apparatus according to claim 1, wherein the third logic provides the found hyperparameters as an output to a user.

18. The scientific instrument support apparatus according to claim 1, wherein the first logic, the second logic, and the third logic are implemented by a computing device.

19. The scientific instrument support apparatus according to claim 18, the computing device is implemented in a scientific instrument, wherein the scientific instrument can measure sample spectroscopic data.

20. (canceled)

21. The scientific instrument support apparatus according to claim 1 further comprising a fourth logic, wherein the fourth logic accepts the found hyperparameters and trains the one or more models.

22. The scientific instrument support apparatus according to claim 21 wherein the first logic, the second logic, and the third logic are implemented on a first computing device, and the fourth logic is implemented on a second computing device.

23. The scientific instrument support apparatus according to claim 1 further comprising a fifth logic to manage an application of the one of more trained models to a test sample data to identify, a qualitative or quantitative feature of one or more substances in the test sample.

24. The scientific instrument support apparatus according to claim 23, wherein the first logic, the second logic, and the third logic are implemented on a first computing device, and the fifth logic is implemented on a second computing device.

25. The scientific instrument support apparatus according to claim 24, wherein the second computing device is implemented on a scientific instrument, wherein the scientific instrument can measure sample spectroscopic data.

26. A Raman spectrometer comprising:
a support apparatus including;
first logic to manage and pre-process spectroscopic data sets,
second logic to train one or more models and provide a one or more trained model,
a third logic to provide a measure of the quality of the one or more trained model and provide a one or more found hyperparameter of the one or more trained model, and
a fifth logic to manage an application of the trained models to a test sample data to identify, a qualitative or quantitative feature of one or more substances in the test sample.

27. A method to identify, authenticate or quantify one or more substances in a sample under test, the method comprising:
irradiating the sample with an excitation beam from a spectroscopy device;
collecting data responsive to the excitation beam using the spectroscopy device; and
processing the data using a scientific instrument support apparatus according to claim 1.

28. A method for scientific instrument support, comprising:
managing and pre-processing data;
training one or more models to provide a trained models;
providing a measure of the quality of the trained model; and
providing a one or more hyperparameter of the trained model.

29. One or more non-transitory computer readable media having instructions thereon that, when executed by one or more processing devices of a scientific instrument support apparatus, cause the scientific instrument support apparatus to perform the method of claim 28.

30.-32. (canceled)
